(19) United States
(12) Patent Application Publication
(10) Pub. No.: US 2011/0074762 A1
(43) Pub. Date: Mar. 31, 2011

(54) LIGHT-EMITTING APPARATUS AND DRIVE CONTROL METHOD THEREOF AS WELL AS ELECTRONIC DEVICE

(75) Inventors: Tomoyuki SHIRASAKI, Higashiyamato-shi (JP); Shunji Kashiyama, Sagamihara-shi (JP); Satoru Shimoda, Tokyo (JP)

(73) Assignee: CASIO COMPUTER CO., LTD., Tokyo (JP)

(21) Appl. No.: 12/892,172

(22) Filed: Sep. 28, 2010

(30) Foreign Application Priority Data
Sep. 30, 2009 (JP) 2009-226122
Aug. 3, 2010 (JP) 2010-174575

(51) Int. Cl. G09G 3/30; G09G 5/00

(52) U.S. Cl. 345/211; 345/76

(57) ABSTRACT

A light-emitting apparatus includes a light-emitting panel provided with at least one pixel and a data line connected to the pixel, and a drive circuit connected to the light-emitting panel. The pixel includes a light-emitting element, a drive transistor, and a switching element. The drive transistor includes a current path having a first end side connected to the light-emitting element and a second end side to be supplied with a power supply voltage. The switching element is provided between the first end side of the current path and the data line. The drive circuit includes a measurement circuit, which connects the data line and light-emitting element through the switching element after no current is set to run through the current path, to acquire an electric characteristic of the light-emitting element through the data line and first switching element.

### CROSS-REFERENCE TO RELATED APPLICATIONS

This application is based upon and claims the benefit of priority from prior Japanese Patent Application No. 2009-226122, filed Sep. 30, 2009, and Japanese Patent Application No. 2010-174575, filed Aug. 3, 2010, the entire contents of which are incorporated herein by references.

### BACKGROUND OF THE INVENTION

1. Field of the Invention

The present invention relates to a light-emitting apparatus and a drive control method thereof as well as an electronic device. More particularly, the present invention relates to a light-emitting apparatus comprising a light-emitting panel, a drive control method thereof as well as an electronic device to which such light-emitting apparatus is applied. In the light-emitting panel, there are arranged pixels having current-driven light-emitting elements which are supplied with a current corresponding to image data and thereby emit light with a desired luminance gradation.

2. Description of the Related Art

Recently, a light-emitting element type display apparatus (light-emitting element type display, light-emitting apparatus) has been attracting attention as a next-generation display device following a liquid crystal display apparatus. This light-emitting element type display apparatus includes a display panel in which current-driven (or current-controlled) light-emitting elements such as organic electroluminescent elements (organic EL elements) or light-emitting diodes (LED) are arranged in matrix form.

In particular, a light-emitting element type display to which an active-matrix drive method is applied has such a good display characteristic as a higher display response speed and lower viewing angle dependence, as compared with the liquid crystal display apparatus.

Moreover, the light-emitting element type display has an advantage in its device configuration of needing no backlight and no light guide plate in contrast with the liquid crystal display apparatus. It is therefore expected that the light-emitting element type display may be applied to various electronic devices in the future.

For example, an organic EL display apparatus described in Jpn. Pat. Appln. KOKAI Publication No. 8-330600 is an active-matrix-driven display apparatus which is current-controlled by a voltage signal. This organic EL display apparatus is provided with, pixel by pixel, a current control thin film transistor for passing a current through an organic EL element when a voltage signal corresponding to image data is applied to the gate of this transistor, and a switch thin film transistor for switching to supply the voltage signal corresponding to the image data to the gate of the current control thin film transistor.

In such an organic EL display apparatus (light-emitting element type display), the organic EL element which is a light-emitting element may change in its light emission characteristic (deteriorate with time). The deterioration in the light emission characteristic of the organic EL element with time is attributed to the following fact: The conduction resistance of the organic EL element changes. This leads to a change in the electric characteristic of the organic EL element including the relation between a voltage applied to the organic EL element and a current running through the organic EL element in the light-emitting operation of the organic EL element.

In the event of such deterioration in the light emission characteristic with time, a desired luminance gradation is not obtained even if a gradation voltage having a voltage value corresponding to image data is applied to the pixel.

### BRIEF SUMMARY OF THE INVENTION

The present invention has an advantage to provide a light-emitting apparatus that allows the light-emitting element to emit light with a proper luminance gradation corresponding to the image data, a drive control method of the apparatus, and an electronic device to which the light-emitting apparatus is applied.

In order to provide the above advantage, a light-emitting apparatus of the present invention includes a light-emitting panel provided with at least one pixel and a data line connected to the pixel, and a drive circuit connected to the light-emitting panel. The pixel includes a light-emitting element, a drive transistor, and a first switching element. The drive transistor includes a current path having a first end side connected to the light-emitting element and a second end side to be supplied with a power supply voltage. The first switching element is provided between the first end side of the current path of the drive transistor and the data line. The drive circuit includes a measurement circuit, which connects the data line and the light-emitting element through the first switching element after no current is set to run through the current path of the drive transistor, acquiring an electric characteristic of the light-emitting element through the data line and the first switching element, the electric characteristic comprising a relation between a voltage applied to the light-emitting element and a current running through the light-emitting element.

In order to provide the above advantage, an electronic device of the present invention includes an electronic device main unit, and a light-emitting apparatus to be supplied with image data from the electronic device main unit and driven in accordance with the image data. The light-emitting apparatus includes a light-emitting panel provided with at least one pixel and a data line connected to the pixel, and a drive circuit connected to the light-emitting panel. The pixel includes a light-emitting element, a drive transistor, and a first switching element. The drive transistor includes a current path having a first end side connected to the light-emitting element ado a second end side to be supplied with a power supply voltage. The first switching element is provided between the first end side of the current path of the drive transistor and the data line. The drive circuit includes a measurement circuit, which connects the data line and the light-emitting element through the first switching element after no current is set to run through the current path of the drive transistor, acquiring an electric characteristic of the light-emitting element through the data line and the first switching element, the electric characteristic comprising a relation between a voltage applied to the light-emitting element and a current running through the light-emitting element.

In order to provide the above advantage, a drive control method of the present invention of a light-emitting apparatus, which includes a data line and at least one pixel, the pixel including a light-emitting element, a drive transistor provided with a current path having a first end side connected to the light-emitting element and a second end side to be supplied with a power supply voltage, and a first switching element provided between the first end side of the current path of the drive transistor and the data line, includes a cutting step of setting no current to run through the current path of the drive transistor, a connecting step of connecting the data line and the light-emitting element through the first switching element after the cutting step is executed, and a characteristic measuring step of acquiring an electric characteristic of the light-emitting element through the data line and the first switching element with the data line and the light-emitting element being connected through the first switching element by the connecting step, the electric characteristic comprising a relation between a voltage applied to the light-emitting element and a current running through the light-emitting element.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic block diagram showing one example of the overall configuration of a light-emitting apparatus according to the present invention when applied to a display apparatus;

FIG. 2 is an essential configuration diagram showing one example of a display panel and its peripheral circuits applied to a display apparatus according to a first embodiment;

FIG. 3 is a schematic block diagram showing one example of a data driver applicable to the display apparatus according to the first embodiment;

FIG. 4 is an essential configuration diagram showing one example of the periphery of an output circuit of the data driver applicable to the display apparatus according to the first embodiment;

FIG. 5 is a circuit configuration diagram showing one embodiment of a pixel applied to the display panel according to the first embodiment;

FIGS. 6A and 6B are timing charts showing a luminance compensation data acquiring operation in the display apparatus according to the first embodiment;

FIG. 7 is an operation concept diagram showing an initializing operation in the display apparatus according to the first embodiment;

FIG. 8 is an operation concept diagram showing an off-voltage applying operation in the display apparatus according to the first embodiment;

FIG. 9 is an operation concept diagram showing a current measuring operation in the display apparatus according to the first embodiment;

FIGS. 10A, 10B and 10C are diagrams for illustrating the variation in the electric characteristic of an organic EL element;

FIG. 11 is a timing chart in the case where the luminance compensation data acquiring operation according to the first embodiment is applied to a display panel in which pixels are two-dimensionally arranged;

FIGS. 12A and 12B are timing charts showing a display operation in the display apparatus according to the first embodiment;

FIG. 13 is an operation concept diagram showing a reset operation in the display apparatus according to the first embodiment;

FIG. 14 is an operation concept diagram showing a gradation voltage writing operation in the display apparatus according to the first embodiment;

FIG. 15 is an operation concept diagram showing a light emission operation in the display apparatus according to the first embodiment;

FIG. 16 is a timing chart in the case where the display operation according to the first embodiment is applied to the display panel in which pixels are two-dimensionally arranged;

FIG. 17 is a timing chart showing a pixel defect detecting operation in the display apparatus according to the first embodiment;

FIG. 18 is an operation concept diagram showing an off-voltage applying operation in the pixel defect detecting operation according to the first embodiment;

FIG. 19 is an operation concept diagram showing a current measuring operation in the pixel defect detecting operation according to the first embodiment;

FIG. 20 is an essential configuration diagram showing one example of a display panel and its peripheral circuits (drive circuits) applied to a display apparatus according to a second embodiment;

FIG. 21 is an essential configuration diagram showing one example of a data driver applied to the second embodiment;

FIG. 22 is a circuit configuration diagram showing one embodiment of a pixel applied to a display panel according to the second embodiment;

FIGS. 23A and 23B are timing charts showing a luminance compensation data acquiring operation in the display apparatus according to the second embodiment;

FIG. 24 is an operation concept diagram showing an initializing operation in the display apparatus according to the second embodiment;

FIG. 25 is an operation concept diagram showing an off-voltage applying operation in the display apparatus according to the second embodiment;

FIG. 26 is an operation concept diagram showing a current measuring operation in the display apparatus according to the second embodiment;

FIG. 27 is a timing chart in the case where the luminance compensation data acquiring operation according to the second embodiment is applied to a display panel in which pixels are two-dimensionally arranged;

FIG. 28 is a timing chart showing a display operation in the display apparatus according to the second embodiment;

FIG. 29 is an operation concept diagram showing a reset operation in the display apparatus according to the second embodiment;

FIG. 30 is an operation concept diagram showing a gradation voltage writing operation in the display apparatus according to the second embodiment;

FIG. 31 is an operation concept diagram showing a light emission operation in the display apparatus according to the second embodiment;

FIG. 32 is a timing chart in the case where the display operation according to the second embodiment is applied to the display panel in which pixels are two-dimensionally arranged;

FIG. 33 is a timing chart showing a pixel defect detecting operation in the display apparatus according to the second embodiment;

FIG. 34 is an operation concept diagram showing an off-voltage applying operation in the pixel defect detecting operation according to the second embodiment;

FIG. 35 is an operation concept diagram showing a current measuring operation in the pixel defect detecting operation according to the second embodiment;

FIGS. 36A and 36B are perspective views showing the configuration of a digital camera according to a third embodiment;

FIG. 37 is a perspective view showing the configuration of a personal computer according to the third embodiment; and

FIG. 38 is a view showing the configuration of a mobile telephone according to the third embodiment.

### DETAILED DESCRIPTION OF THE INVENTION

Hereinafter, a light-emitting apparatus and a drive control method thereof according to embodiments of the present invention will be described in detail. In the embodiments, the light-emitting apparatus is described as a display apparatus.

### First Embodiment

### Light-Emitting Apparatus

First, a schematic configuration of a light-emitting apparatus according to the present invention when applied to a display apparatus is described with reference to the drawings.

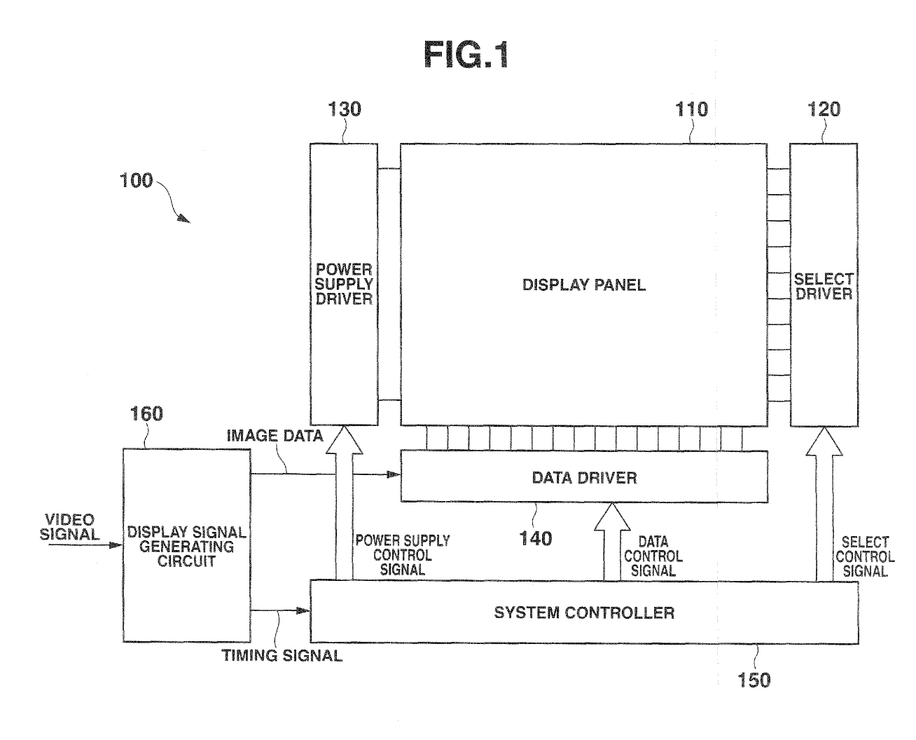

FIG. 1 is a schematic block diagram showing one example of the overall configuration of the light-emitting apparatus according to the present invention when applied to the display apparatus.

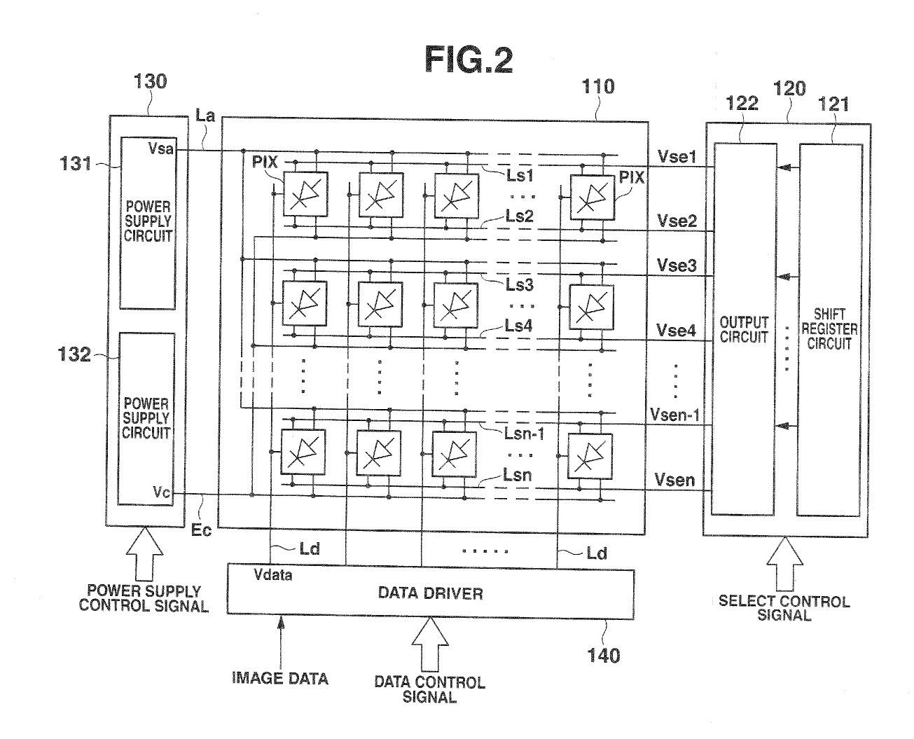

FIG. 2 is an essential configuration diagram showing one example of a display panel (light-emitting panel) and its peripheral circuits (drive circuits) applied to a display apparatus according to a first embodiment.

As shown in FIG. 1, a display apparatus 100 (light-emitting apparatus) according to the present embodiment generally includes a display panel 110 (light-emitting panel), a select driver 120, a power supply driver 130, a data driver 140, a system controller 150, and a display signal generating circuit 160. Here, the select driver 120, the power supply driver 130, the data driver 140, the system controller 150, and the display signal generating circuit 160 constitute a drive circuit in the present invention.

As shown in FIG. 2, the display panel 110 is provided with pixels PIX, select lines Ls1 to Lsn, a power supply line La, a common electrode Ec and data lines Ld.

The pixels PIX are two-dimensionally arranged in a row direction (lateral direction of the drawing) and column direction (longitudinal direction of the drawing) of the display panel 110 (e.g., n/2 rows×m columns; n is an even positive integral number, and m is a positive integral number).

The select lines Ls1 to Lsn are provided to be connected to the pixels PIX arranged in the row direction of the display panel 110.

The power supply line La is provided so that this common power supply line La is connected to all the pixels PIX of the display panel 110.

The common electrode Ec is provided so as to be connected to all the pixels PIX of the display panel 110. The common electrode Ec comprises, for example, a single electrode layer (solid electrode).

Each of the data lines Ld are provided to be connected to the pixels PIX that are arranged in the column direction of the display panel 110.

Here, in the display panel 110 according to the present embodiment, pairs of select lines Ls1 and Ls2, Ls3 and Ls4, . . . , and Lsn−1 and Lsn are connected to the pixels PIX in the respective rows. Each pixel PIX has a pixel drive circuit and a light-emitting element, as described later.

The select driver 120 is connected to the select lines Ls1 to Lsn provided in the display panel 110. The select driver 120 sequentially applies select signals Vse1 and Vse2, Vse3 and Vse4, . . . , and Vsen−1 and Vsen at a predetermined voltage level to the pairs of select lines Ls1 and Ls2, Ls3 and Ls4, . . . , and Lsn−1 and Lsn in the respective rows by predetermined timing.

Here, the select driver 120 includes a shift register 121 and an output circuit 122, for example, as shown in FIG. 2.

The shift register 121 sequentially outputs shift signals corresponding to the select lines Ls1 to Lsn in the respective rows in accordance with a select control signal (e.g., a scan clock signal and a scan start signal) supplied from the later-described system controller 150.

The output circuit 122 converts the shift signals output from the shift register 121 into a predetermined signal level (select level; e.g., high level).

The output circuit 122 then outputs the converted shift signals to the select lines Ls1 to Lsn as the select signals Vse1 to Vsen in accordance with the select control signal (e.g., output control signal) supplied from the system controller 150.

The power supply driver 130 is connected to the individual power supply line La which is connected to the pixels PIX of the display panel 110 in a shared manner, and to the common electrode Ec. The power supply driver 130 individually applies predetermined power supply voltages Vsa, Vc to each power supply line La and the common electrode Ec by predetermined timing.

Here, for example, as shown in FIG. 2, the power supply driver 130 includes a power supply circuit 131 to supply the power supply voltage Vsa at a predetermined signal level to each power supply line La and a power supply circuit 132 to supply a power supply voltage Vc at a predetermined signal level to the common electrode Ec synchronously with the application timing of the above-mentioned select signals Vse1 to Vsen in accordance with a power supply control signal (e.g., output control signal) supplied from the system controller 150.

The data driver 140 is connected to each data line Ld of the display panel 110. The data driver 140 generates a gradation signal (gradation voltage Vdata) corresponding to image data and supplies the gradation signal to the pixel PIX through each data line Ld during at least a display operation.

The data driver 140 applies a reference voltage Vmeas having a particular voltage value to each data line Ld during a later-described luminance compensation data acquiring operation. The data driver 140 then measures the value of a current Imeas which runs through each pixel PIX (specifically, light-emitting element) in conformity to the reference voltage Vmeas, thereby acquiring the value as luminance compensation data.

Furthermore, the data driver 140 acquires a variation in the light emission characteristic of each light-emitting element in accordance with the value of the applied reference voltage Vmeas, the value of the measured current Imeas and a predetermined reference value.

During the display operation, the data driver 140 supplies each pixel PIX with, through each data line Ld, the gradation voltage Vdata the value of which has been corrected to compensate for the change in the light emission characteristic in accordance with the image data and on the basis of the acquired variation in the light emission characteristic or each light-emitting element.

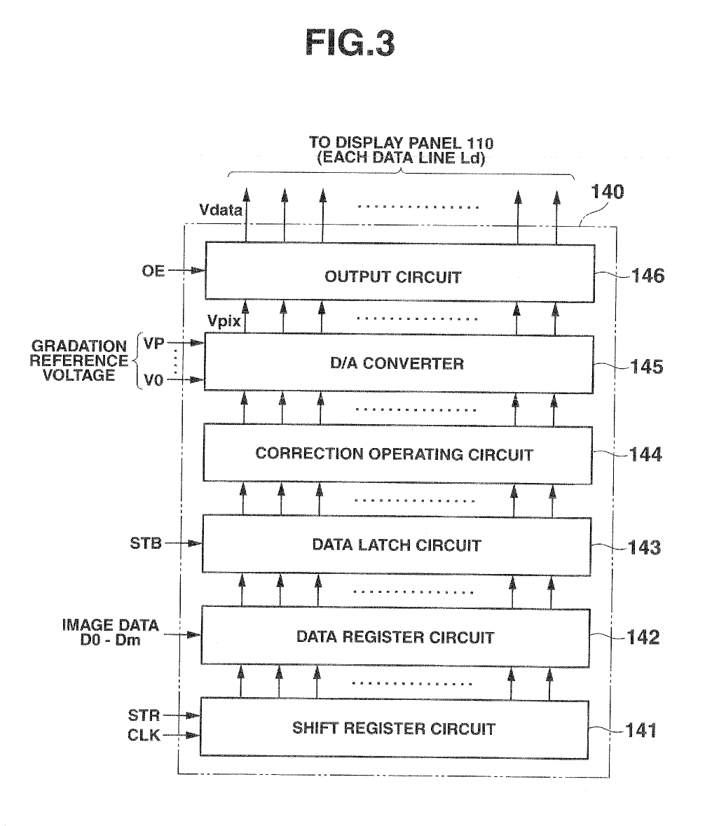

FIG. 3 is a schematic block diagram showing one example of the data driver applicable to the display apparatus according to the present embodiment.

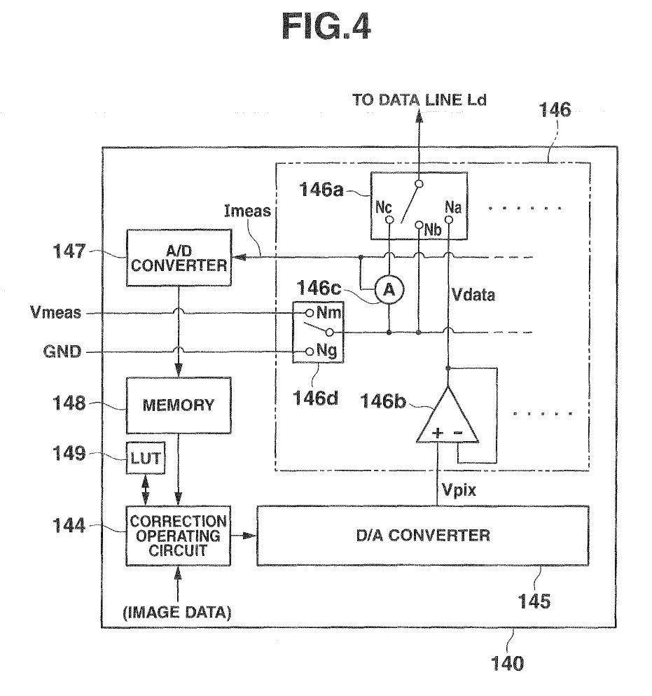

FIG. 4 is an essential configuration diagram showing one example of the periphery of the output circuit of the data driver shown in FIG. 3.

Here, in FIG. 4, a shift register circuit, a data register circuit and a data latch circuit shown in FIG. 3 are omitted to show the data driver 110 in a simplified form.

For example, as shown in FIG. 3 and FIG. 4, the data driver 140 includes a shift register circuit 141, a data register circuit 142, a data latch circuit 143, a correction operating circuit 144, a D/A converter 145 (voltage applying circuit), an output circuit 146 (current measurement circuit), an A/D converter 147, a memory 148 (storage circuit), and an LUT (reference value storage circuit) 149.

The shift register circuit 141 sequentially outputs a shift signal in accordance with a data control signal (shift clock signal CLK, sampling start signal SIR) supplied from the system controller 150.

The data register circuit 142 sequentially loads image data D0 to Dm for one row supplied from the display signal generating circuit 160, in accordance with the input timing of the shift signal.

The data latch circuit 143 holds the image data D0 to Dm for one row loaded onto the data register circuit 142, in accordance with the data control signal (data latch signal STB).

The correction operating circuit 144 corrects the image data D0 to Dm held in the data register circuit 142 in accordance with the luminance compensation data which has been extracted in advance by the later-described luminance compensation data acquiring operation and which corresponds to the variation in the light emission characteristic of each pixel PIX (light-emitting element).

The D/A converter 145 converts the image data D0 to Dm or the image data D0 to Dm after the above-mentioned correction (hereinafter referred to as “corrected image data D0′ to Dm′” for convenience) into a predetermined analog signal voltage Vpix in accordance with gradation reference voltages V0 to VP supplied from unshown power supply means.

The output circuit 146 converts the image data D0 to Dm which have been converted into the analog signal voltage or the corrected image data D0′ to Dm′ into the gradation voltage Vdata at a predetermined signal level. The output circuit 146 then simultaneously outputs the gradation voltage Vdata to the data line Ld in each row in accordance with a data control signal (output switching/enable signal OE) supplied from the system controller 150.

In particular, as shown in FIG. 4, the data driver 140 applied in the present embodiment has, in the output circuit 146, a changeover switch 146a, a follower amplifier 146b, an ammeter 146c, and a changeover switch 146d.

The changeover switch 146a selectively connects the data line Ld in each row to one of contacts Na, Nb, and Nc in accordance with a data control signal supplied from the system controller 150. The contact Na is connected to the D/A converter 145 through the follower amplifier 146b. The contact Nb is connected to the changeover switch 146d. The contact Nc is connected to the changeover switch 146d through the ammeter 146c.

The follower amplifier 146b acts as a buffer circuit for the output of the D/A converter 145. As a result, the analog signal voltage Vpix corresponding to the image data D0 to Dm (or the corrected image data D0′ to Dm′) output from the D/A converter 145 is converted into the gradation voltage Vdata by the follower amplifier 146b, and applied to each data line Ld through the changeover switch 146a.

The ammeter 146c detects the value of the current Imeas running through the light-emitting element (organic EL element described later) of each pixel PIX when the predetermined reference voltage Vmeas is applied to each data line Ld through the ammeter 146c during the later-described luminance compensation data acquiring operation.

The changeover switch 146d selectively connects the data line Ld in each row to one of contacts Nm and Ng directly or indirectly through the ammeter 146c in accordance with the data control signal supplied from the system controller 150. The reference voltage Vmeas having a predetermined value is applied to the contact Nm from an unshown power supply. Moreover, the contact Ng is set at a ground potential GND.

Thus, when the pixels PIX arranged in the display panel 110 are initialized or reset, the data driver 140 (output circuit 146) connects the changeover switch 146a to the contact Nb, and connects the changeover switch 146d to the contact Ng, thereby setting the data line Ld at the ground potential GND.

When the image data is written into each pixel PIX, the data driver 140 (output circuit 146) connects the changeover switch 146a to the contact Na, thereby applying the gradation voltage Vdata corresponding to the image data to the data line Ld.

When the luminance compensation data for compensating for the light emission characteristic of each pixel PIX is acquired, the data driver 140 (output circuit 146) connects the changeover switch 146a to the contact Nc and connects the changeover switch 146d to the contact Nm so that the value of the current Imeas running through the data line Ld is measured by the ammeter 146c.

Here, although described in detail later, the operation of applying a particular off-voltage Voff to the data line Ld is performed before the operation of measuring the value of the current Imeas running through the data line Ld by the ammeter 146c, during the luminance compensation data acquiring operation. In order to generate this off-voltage Voff, for example, off-voltage data is loaded instead of the image data D0 to Dm through the data register circuit 142 and supplied to the D/A converter 145 in the configuration of the data driver 140. The off-voltage Voff is supplied to each data line Ld from the output circuit 146 by predetermined timing. At the same time, the changeover switch 146a is connected to the contact Na.

The method of generating and supplying the off-voltage. Voff is not limited to the method of supplying the off-voltage data to the data driver 140. For example, to the method of generating and supplying the off-voltage Voff, a configuration in which an unshown constant voltage source (voltage generating circuit) is provided outside the output circuit 146 or data driver 140 can be applied. This allows the off-voltage Voff having a particular voltage value to be supplied to each data line Ld from the constant voltage source by predetermined timing during the luminance compensation data acquiring operation.

The A/D converter 147 converts, into a digital value, the value of the current Imeas which is an analog value detected by the ammeter 146c during the luminance compensation data acquiring operation. Here, the value of the digitally converted current Imeas corresponds to the luminance compensation data for compensating for the light emission characteristic (specifically, a current-voltage characteristic concerning the light emission luminance of the light-emitting element) of each pixel PIX.

The memory 148 stores, as the luminance compensation data corresponding to each pixel PIX, the value of the current Imeas which has been converted into the digital value by the A/D converter 147.

The LUT 149 is d lookup table which stores a reference value for extracting the variation in the light emission characteristic of each light-emitting element in the luminance compensation data acquiring operation. This reference value is, for example, an initial value of the current Imeas or a design value of the current Imeas which is detected by the ammeter 146c when each light-emitting element has an initial characteristic.

The correction operating circuit 144 extracts the variation in the light emission characteristic of each light-emitting element in accordance with, for example, the difference between the luminance compensation data stored in the memory 148 and the reference value stored in the LUT 149. The correction operating circuit 144 then extracts a correction amount necessary to compensate for the variation in the light emission characteristic of each light-emitting element. Thus, during the display operation in which each pixel PIX (light-emitting element) emits light with a luminance gradation corresponding to the image data, the correction operating circuit 144 acquires the variation in the light emission characteristic of each light-emitting element in accordance with the luminance compensation data for each pixel PIX read from the memory 148 and the reference value stored in the LUT 149. The correction operating circuit 144 extracts a correction amount necessary to compensate for this variation, and corrects the image data D0 to Dm in accordance with the extracted correction amount.

Although the memory 148 is provided in the data driver 140 in the configuration shown in the present embodiment as shown in FIG. 4, the present invention is not limited to such a configuration. The memory 148 may be provided as a separate component independent of the data driver 140. Although the LUT 149 is also provided in the data driver 140 in the configuration shown in FIG. 4, the present invention is not limited to such a configuration. The LUT 149 may be provided as a separate component independent of the data driver 140.

The system controller 150 controls the operating state of at least the select driver 120, the power supply driver 130 and the data driver 140 in accordance with a later-described timing signal supplied from the display signal generating circuit 160, and thereby generates and outputs a select control signal, a power supply control signal and a data control signal for performing a predetermined drive control operation in the display panel 110.

Particularly in the present embodiment, the system controller 150 supplies the select control signal, the power supply control signal and the data control signal to the select driver 120, the power supply driver 130 and the data driver 140, respectively. Thus, the system controller 150 operates each of the drives by predetermined timing. Accordingly, the select driver 120 generates and outputs the select signals Vse1 to Vsen at the predetermined voltage level. The power supply driver 130 generates and outputs the power supply voltages Vsa, Vc. The data driver 140 generates and outputs the reference voltage Vmeas for acquiring the luminance compensation data, the off-voltage Voff, and the gradation voltage Vdata corresponding to the image data.

Thus, under the control of the system controller 150, the drive control operation (the later-described luminance compensation data acquiring operation and the display operation) is sequentially performed in each pixel PIX so that predetermined image information based on a video signal is displayed on the display panel 110.

The display signal generating circuit 160 generates image data (luminance gradation data) on the basis of, for example, the video signal supplied from the outside of the display apparatus 100, and supplies the image data to the data driver 140. The display signal generating circuit 160 also extracts or generates a timing signal (e.g., system clock) for displaying predetermined image information on the display panel 110 in accordance with the image data, and supplies the timing signal to the system controller 150.

Specifically, the display signal generating circuit 160 extracts a luminance gradation signal component from the video signal, and supplies the luminance gradation signal component to the data register circuit 112 of the data driver 140 as image data (luminance gradation data) comprising a digital signal for each row of the display panel 110. Here, when the video signal includes a timing signal component for regulating the display timing of the image information as in the case of a television broadcast signal (composite video signal), the display signal generating circuit 160 may have a function of extracting the timing signal component and supplying the timing signal component to the system controller 150 in addition to a function of extracting the luminance gradation signal component. In this case, the system controller 150 generates the control signals to be individually supplied to the select driver 120, the power supply driver 130 and the data driver 140 in accordance with the timing signal supplied from the display signal generating circuit 160.

(Pixels)

Now, the pixels arranged in the display panel according to the present embodiment are described in detail.

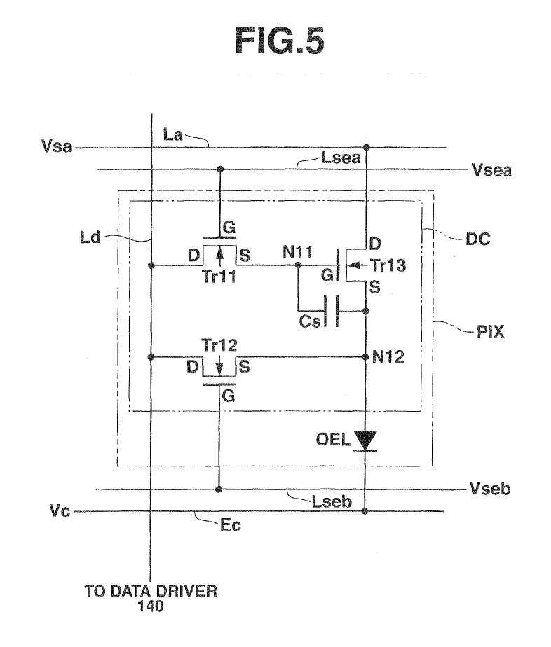

FIG. 5 is a circuit configuration diagram showing one embodiment of a pixel (a pixel drive circuit and a light-emitting element) applied to the display panel according to the present embodiment.

As shown in FIG. 5, each of the pixels PIX arranged in the display panel 110 according to the present embodiment includes a pixel drive circuit DC and an organic EL element (current-driven light-emitting element) OEL.

The pixel drive circuit DC sets the pixel PIX to a selected state on the basis of at least a select signal Vsea (Vse1, Vse3, . . . , and Vsen1) applied from the select driver 120 through a select line Lsea (Ls1, Ls3, . . . , and Lsn1) and a select signal Vseb (Vse2, Vse4, . . . , and Vsen) applied through a select line Lseb (Ls2, Ls4, . . . , and Lsn).

The pixel drive circuit. DC generates a light emission drive current corresponding to the gradation voltage Vdata supplied from the data driver 140 through the data line Ld in this selected state.

The organic EL element OEL emits light with a desired luminance gradation in accordance with the light emission drive current generated by the pixel drive circuit DC.

Specifically, the pixel drive circuit DC shown in FIG. 5 includes transistors Tr11 to Tr13 and a capacitor Cs.

Each of the transistors Tr11 to Tr13 has a gate terminal, a drain terminal and a source terminal, and has a current path formed between the drain terminal and source terminal.

The transistor Tr11 (second switching element) has its gate terminal connected to the select line Lsea (Ls1, Ls3, . . . , and Lsn1), its drain terminal connected to the data line Ld, and its source terminal connected to a contact N11.

The transistor Tr12 (first switching element) has its gate terminal connected to the select line Lseb (Ls2, Ls4, . . . , and Lsn), its drain terminal connected to the data line Ld, and its source terminal connected to a contact N12. The transistor Tr13 (drive transistor) has its gate terminal connected to the contact N11, its drain terminal connected to the power supply line La, and its source terminal connected to the contact N12.

The capacitor Cs (storage capacitance) is provided to be connected between the gate terminal (contact N11) and source terminal (contact N12) of the transistor Tr13.

That is, in the present embodiment, a pair of (two) select lines Lsea, Lseb are connected to one pixel PIX.

The organic EL element OEL has its anode (anode electrode) connected to the contact N12 of the pixel drive circuit DC, and its cathode (cathode electrode) connected to the common electrode Ec.

Although the transistors Tr11 to Tr13 are not particularly limited in the pixel PIX shown in FIG. 5, known thin film transistors (TFT) all having the same channel type, for example, can be applied. In the case shown in FIG. 5, the transistors Tr11 to Tr13 comprise n-channel thin film transistors.

The transistors Tr11 to Tr13 may be amorphous silicon thin film transistors or polycrystalline (poly-) silicon thin film transistors.

Particularly when the transistors Tr11 to Tr13 comprise n-channel amorphous silicon thin film transistors, transistors having uniform and stable operating characteristics (e.g., electron mobility) can be obtained in a simple manufacturing process by applying an already established amorphous silicon manufacturing technique as compared with polycrystalline or monocrystalline thin film transistors. Moreover, the capacitor Cs may be a parasitic capacitance formed between the gate and source of the transistor Tr13, or may be a separate capacitative element connected in series in addition to the above parasitic capacitance.

Although the circuit configuration comprising the three transistors Tr11 to Tr13 has been shown as the pixel drive circuit DC in the pixel PIX described above, the present invention is not limited to this embodiment. The pixel drive circuit. DC may have any other configuration comprising three or more transistors. Moreover, in the shown circuit configuration, the organic EL element OEL is applied as the light-emitting element that is driven by the pixel drive circuit DC to emit light. However, the present invention is not limited to this. The light-emitting element may be any other light-emitting element such as a light-emitting diode as long as this light-emitting element is a current-driven light-emitting element.

(Drive Control Method of Light-Emitting Apparatus)

Now, a drive control method of the display apparatus according to the present embodiment is described.

The drive control operation of the display apparatus 100 according to the present embodiment includes at least the luminance compensation data acquiring operation and the display operation.

In the luminance compensation data acquiring operation, a parameter to compensate for a change in the light emission characteristic of the pixels PIX arranged in the display panel 110 is acquired. More specifically, the following operation is performed: As a parameter for extracting the degree (amount) of a change with time (deterioration with time) in the current-voltage characteristic concerning the light emission luminance, of the organic EL element OEL (light-emitting element) OEL of each pixel PIX, the value of the current (current Imeas) running through the organic EL element OEL when a particular voltage (reference voltage Vmeas) is applied is measured. This value is acquired as luminance compensation data.

In the display operation, a correction amount based on the luminance compensation data acquired for each pixel PIX in the above-mentioned luminance compensation data acquiring operation is extracted. The image data D0 to Dm are corrected in accordance with the extracted correction amount. The gradation voltage Vdata corresponding to the corrected image data D0′ to Dm′ is written into each pixel PIX. As a result, the organic EL element OEL is supplied with a light emission drive current having a value obtained after the variation in the light emission characteristic of each pixel PIX (the variation in the current-voltage characteristic of the organic EL element OEL) has been compensated for. The organic EL element OEL thus emits light with a luminance gradation corresponding to the image data.

Each operation is described in detail below.

(Luminance Compensation Data Acquiring Operation)

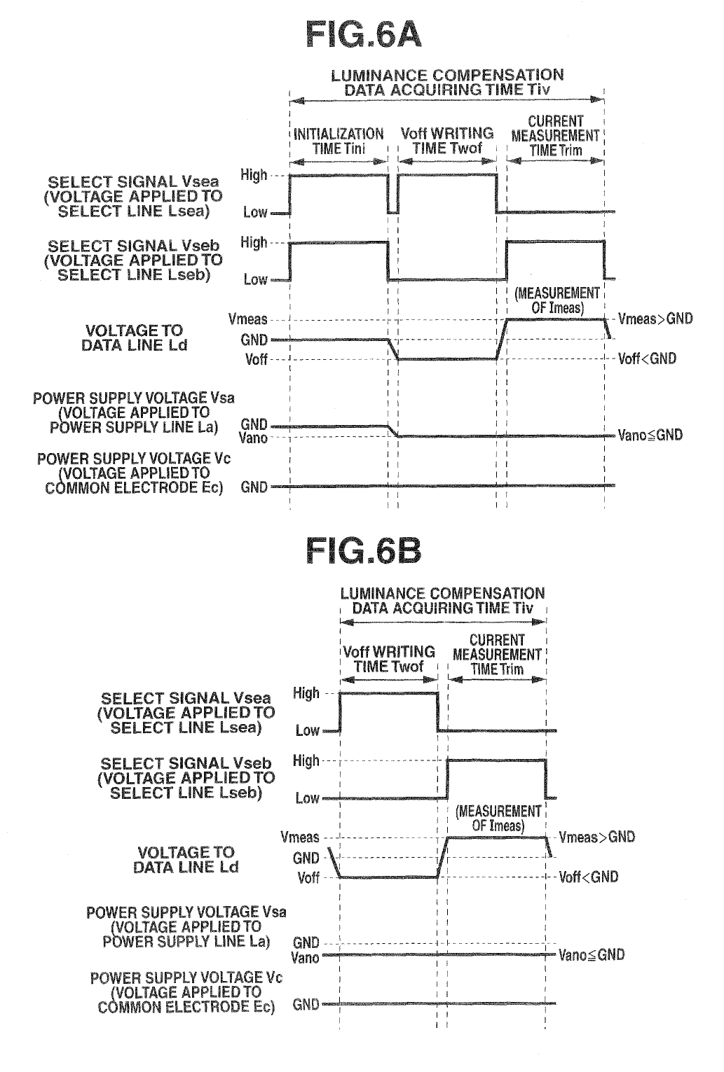

FIGS. 6A and 6B are timing charts showing the luminance compensation data acquiring operation in the display apparatus according to the present embodiment.

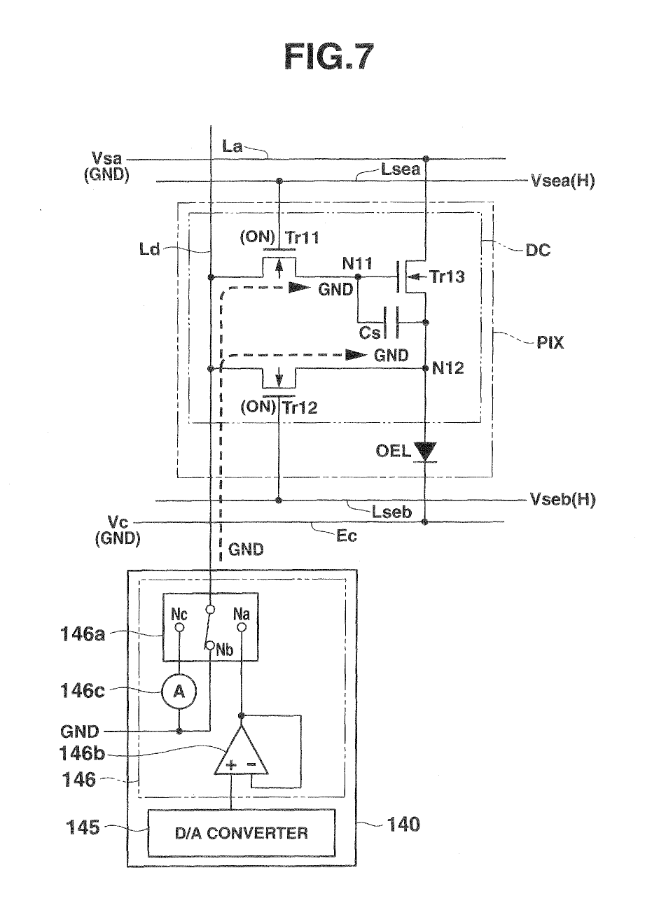

FIG. 7 is an operation concept diagram showing an initializing operation in the display apparatus according to the present embodiment.

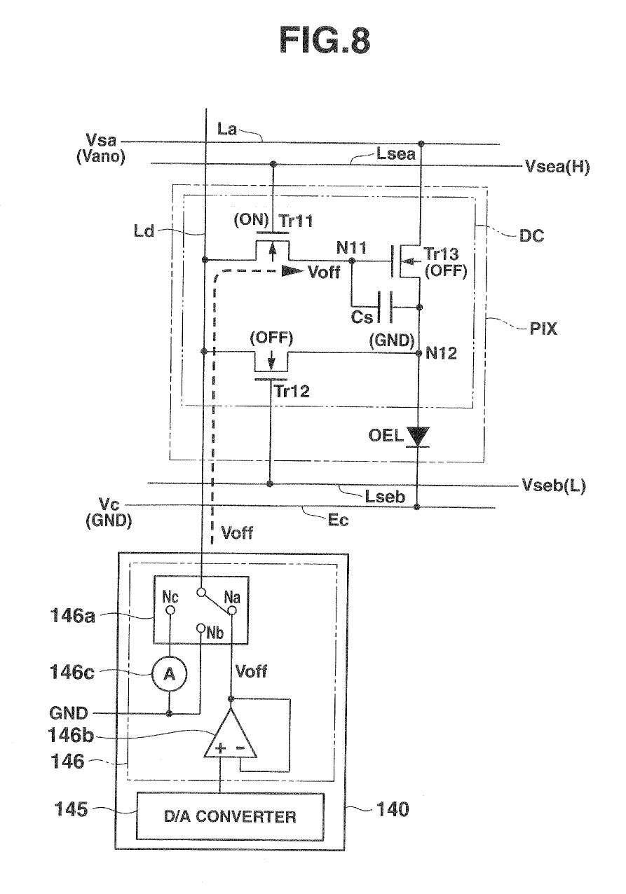

FIG. 8 is an operation concept diagram showing an off-voltage applying operation in the display apparatus according to the present embodiment.

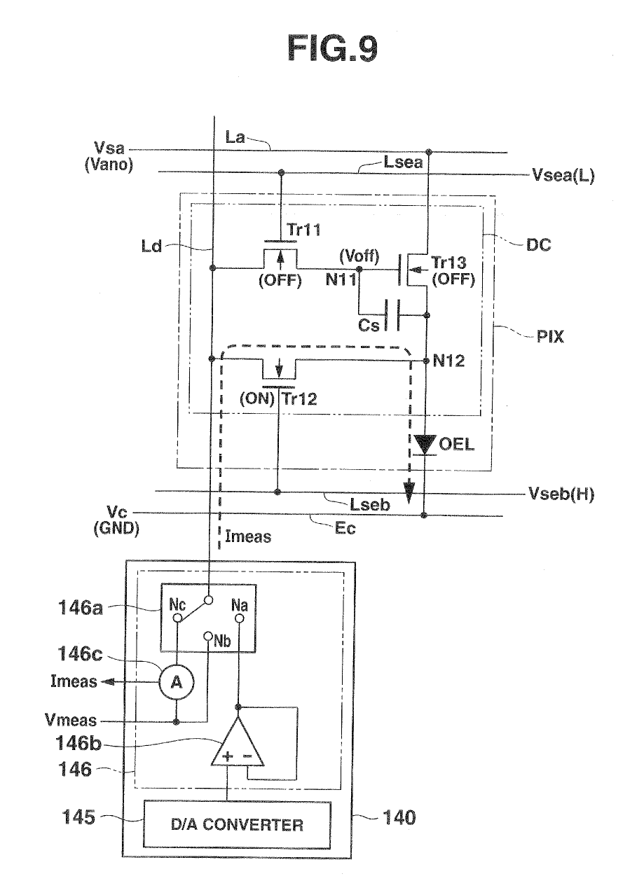

FIG. 9 is an operation concept diagram showing a current measuring operation in the display apparatus according to the present embodiment.

Here, in FIG. 7 to FIG. 9, the D/A converter 145 and the output circuit 146 are only shown as the components of the data driver 140 for convenience of illustration. In the output circuit 146, the changeover switch 146d is omitted, and a voltage supplied by switching/connection is only shown.

The luminance compensation data acquiring operation according to the present embodiment is performed to have a predetermined luminance compensation data acquiring time Tiv shown in FIG. 6A. The luminance compensation data acquiring time Tiv includes an initialization time Tini, a Voff writing time Twof and a current measurement time Trim.

In the initialization time Tini, a charge remaining or held in the data line Ld or pixel PIX is discharged, and the pixel PIX is initialized. In the Voff writing time Twof, the off-voltage Voff is written into the pixel PIX.

In the current measurement time Trim, the reference voltage Vmeas is applied to the data line Ld, and the current Imeas running through the pixel PIX (organic EL element OEL) is thereby measured.

First, in the initialization time Tini, the select driver 120 applies the select signals Vsea and Vseb at a high level (select level) to the select lines Lsea and Lseb connected to the pixel PIX in accordance with the select control signal supplied from the system controller 150, as shown in FIG. 6A and FIG. 7.

Furthermore, the power supply driver 130 (power supply circuits 131, 132) applies the power supply voltages Vsa and Vc at a low level (e.g., ground potential GND) to the power supply line La and the common electrode Ec in accordance with the power supply control signal supplied from the system controller 150.

Synchronously with this timing, in accordance with the data control signal supplied from the system controller 150, the data driver 140 switches/connects the changeover switch 146a provided in the output circuit 146 to the contact Nb and also switches/connects the changeover switch 146d to the contact Ng, thereby setting the data line Ld at the ground potential GND (initialization voltage), as shown in FIG. 6A and FIG. 7.

Thus, as shown in FIG. 7, the transistors Tr11 and Tr12 provided in the pixel drive circuit DC of the pixel PIX turn on. Accordingly, the gate terminal (contact N11) and source terminal (contact N12; the anode of the organic EL element OEL) of the transistor Tr13 are set at the ground potential GND, and the drain terminal of the transistor Tr13 and the cathode of the organic EL element OEL are also set at the ground potential GND.

As a result, the charge accumulated in the capacitor Cs connected between the gate and source of the transistor Tr13 and the charge remaining in the data line Ld are discharged, and the pixel PIX and the data line Ld are initialized (initialization step). At the same time, the transistor Tr13 turns off. No current runs through the organic EL element OEL, and the organic EL element OEL does not emit light.

It is not always necessary to perform the operation of turning on the transistor Tr12 to set the potential of the source terminal of the transistor Tr13 at the ground potential GND in accordance with the initialization time Tini shown in FIG. 6A.

That is, even if this operation is not performed, the pixel PIX can be initialized without any problem in most cases. Therefore, in the luminance compensation data acquiring time Tiv, no initialization time Tini may be provided to perform no initializing operation, for example, as in the timing chart shown in FIG. 6B.

However, if the transistor Tr12 is turned on to set the potential of the source terminal of the transistor Tr13 at the ground potential GND, this ensures that the charge accumulated in the capacitor Cs is discharged and the pixel PIX can be thus initialized. Therefore, the above-mentioned initializing operation is preferably performed.

Next, in the Voff writing time Twof, the power supply driver 130 applies the low-level power supply voltage Vsa (e.g., a voltage Vano having a potential lower than the ground potential GND) to the power supply line La and also applies the low-level power supply voltage Vc (e.g., the ground potential GND) to the common electrode Ec in accordance with the power supply control signal, as shown in FIG. 6A and FIG. 8.

In accordance with the select control signal, the select driver 120 applies the select signal Vsea at a high level (select, level) to the select line Lsea and also applies the select signal Vseb at a low level (unselect level) to the select line Lseb.

Synchronously with this timing, as shown in FIG. 6A and FIG. 8, the data driver 140 switches/connects the changeover switch 146a to the contact Na in accordance with the data control signal, thereby applying the off-voltage Voff having a particular voltage value to the data line Ld (off-voltage applying step).

Here, the off-voltage Voff is set at a voltage value that can fully turn off the transistor Tr13 of the pixel drive circuit DC provided in the pixel PIX. Specifically, the off-voltage Voff applied to the gate electrode (contact N11) of the transistor Tr13 of the pixel PIX from the data driver 140 through the data line Ld is set at a voltage value sufficiently lower than the voltage on the anode side (contact N12) of the organic EL element OEL, for example, at a negative voltage value having a potential lower than the ground potential GND.

This off-voltage Voff is generated by the D/A converter 145 and the follower amplifier 146h for, for example, the data driver 140 shown in FIG. 3 by supplying the data register circuit 142 with off-voltage data instead of the image data D0 to Dm.

As a result, the transistor Tr11 provided in the pixel drive circuit DC of the pixel PIX turns on, and the off-voltage Voff is thus applied to the gate electrode (contact N11) of the transistor Tr13, as shown in FIG. 8.

Moreover, the transistor Tr12 turns off, and the potential (GND) of the source terminal (contact N12) of the transistor Tr13 is thus maintained.

The drain terminal of the transistor Tr13 is set at a potential lower than the ground potential GND by the voltage Vano, and the cathode of the organic EL element OEL is set at the ground potential GND.

That is, the gate electrode (contact N11) of the transistor Tr13 is set at a potential sufficiently lower than the voltage (GND) of the source terminal (contact N12) by the voltage (Voff). The drain terminal is also set at a potential lower than the ground potential GND by the voltage (Vano). This ensures that the current path between the drain and source of the transistor Tr13 is closed. Thus, even a minute leak current does not run to the organic EL element OEL from the transistor Tr13 (cutting step).

In the case shown according to the present embodiment, the low-level power supply voltage Vsa supplied to the power supply line La in the Voff writing time Twof is set at the voltage Vano having a potential lower than the ground potential. GND. The present invention is not limited to this. The point of connection of the power supply circuit 131 of the power supply driver 130 to the power supply line La may be severed (the power supply line La may be opened) to set the power supply line La to a high-impedance state.

Furthermore, in the current measurement time Trim (characteristic measuring step), the select driver 120 applies the select signal Vsea at a low level (unselect level) to she select line Lsea and also applies the select signal Vseb at a high level (select level) to the select line Lseb in accordance with the select control signal, as shown in FIG. 6A and FIG. 9.

As in the Voff writing time Twof described above, the power supply driver 130 applies the power supply voltage boa of the voltage Vano having a potential lower than the ground potential GND to the power supply line La and also applies the power supply voltage be having the ground potential GND to the common electrode Ec in accordance with the power supply control signal.

Synchronously with this timing, as shown in FIG. 6A and FIG. 9, the data driver 140 switches/connects the changeover switch 146a to the contact Nc and also switches/connects the changeover switch 146d to the contact Nm in accordance with the data control signal, thereby applying the reference voltage Vmeas to the data line Ld from an unshown measurement power supply through the ammeter 146c (voltage applying step).

Here, the reference voltage Vmeas is set at a potential higher than the ground potential GND which is set in the cathode of the organic EL element OEL (Vmeas>GND). As a result, a voltage to be a forward bias is applied to the organic EL element OEL.

Specifically, the reference voltage Vmeas is set at such a positive voltage value that the value of the current Imeas running to the common electrode Ec from the data line Ld through the transistor Tr12 and the organic EL element OEL can be measured by the ammeter 116c by applying the reference voltage Vmeas to the data line Ld through the ammeter 146c. At the same time, the organic EL element OEL emits light with a luminance corresponding to the value of the current Imeas. When the value of the current Imeas is sufficiently low, the organic EL element OEL is in an almost non-emission state.

Thus, as shown in FIG. 9, the transistor Tr11 provided in the pixel drive circuit DC of the pixel PIX turns off, and the off-voltage Voff applied to the gate electrode (contact N11) of the transistor Tr13 is maintained.

Furthermore, the transistor Tr12 turns on. Accordingly, the source terminal (contact N12) of the transistor Tr13 is connected to the ammeter 146c through the data line Ld, and the reference voltage Vmeas having a positive voltage value is applied to the source terminal (contact N12) through the ammeter 146c and the data line Ld (connecting step).

Moreover, the drain terminal of the transistor Tr13 is set at the power supply voltage Vsa (=Vano) having a potential lower than the ground potential GND, and the cathode of the organic EL element OEL is set at the ground potential GND.

Thus, the reference voltage Vmeas having a potential higher than the ground potential GND is applied to the anode side (contact N12) of the organic EL element OEL, and the cathode side (common electrode Ec) is set at the ground potential GND. Accordingly, the current Imeas corresponding to the potential difference between the reference voltage Vmeas and the ground potential GND and corresponding to the conduction resistance of the organic EL element OEL runs through the organic EL element OEL in a forward direction.

At the same time, the ammeter 146c connected to the data line Ld measures the value of the current Imeas running to the data line Ld and the pixel PIX from the measurement power supply (not shown) for supplying the reference voltage Vmeas (current measuring step).

The value of the current Imeas measured by the ammeter 146c is converted into digital data by the A/D converter 147 shown in FIG. 4, and then stored in the memory 148 as the luminance compensation data.

The memory 148 stores the luminance compensation data in association with the respective pixels PIX (compensation data storing step).

In the case shown according to the present embodiment, the value of the current Imeas which runs through the organic EL element OEL when the particular reference voltage Voices is applied to the pixel PIX is measured only once in the current measurement time Trim.

The present invention is not limited to this. For example, the reference voltages Vmeas having different voltage values may be applied to measure the value of the current Imeas running through the organic EL element OEL at the moment more than one time (e.g., about two or three times). In this case, more than one value can be obtained for each pixel PIX, and luminance compensation data based on these values is stored in the memory 148 in association with the respective pixels PIX.

Here, there will be described the relation between the luminance compensation data (current Imeas converted to digital data) acquired by luminance compensation data acquiring operation described above and the change in the light emission characteristic of the organic EL element OEL provided in the pixel PIX. There will also be described the correction for compensating for the change in the light emission characteristic of the organic EL element OEL.

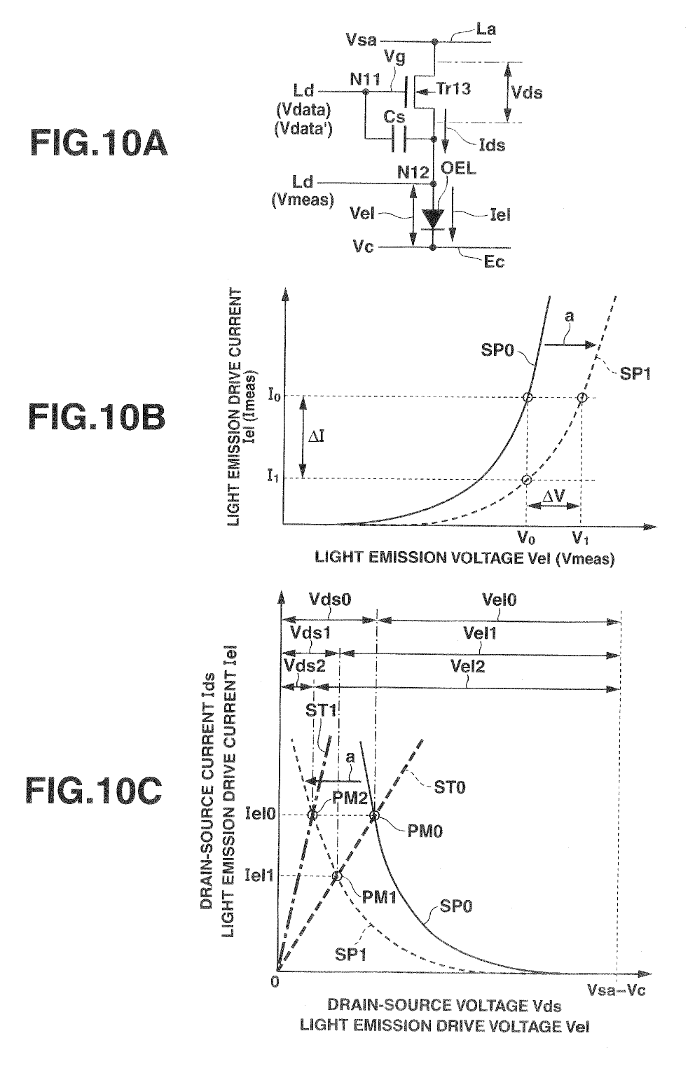

FIGS. 10A, 10B and 10C are diagrams for illustrating the variation in the electric characteristic of the organic EL element.

Here, FIG. 10A is an equivalent circuit diagram associated with the light emission operation of the organic EL element. FIG. 10B is a graph for explaining the change in the electric characteristic of the organic EL element. FIG. 10C is a diagram for explaining the operation state when the electric characteristic of the organic EL element has changed in the equivalent circuit of FIG. 10A.

In the pixel PIX having the circuit configuration shown in FIG. 5, the equivalent circuit in a part associated with the light emission operation (corresponding to the display operation) can be represented as shown in FIG. 10A.

Here, a current (light emission drive current) which runs across the anode and cathode of the organic EL element OEL in order for the organic EL element OEL to emit light with a desired luminance gradation corresponding to image data is Iel. When the light emission drive current Iel is running through the organic EL element OEL, a potential difference (light emission drive voltage) Vel is produced between the anode and cathode of the organic EL element OEL.

In FIG. 10B, the horizontal axis indicates the light emission drive voltage Vel across the anode and cathode of the organic EL element OEL, and the vertical axis indicates the light emission drive current Iel running across the anode and cathode of the organic EL element. OEL. Here, in an initial condition where the organic EL element OEL has an initial characteristic, the electric characteristic of the organic EL element OEL including the relation of the potential difference Vel between the anode and cathode of the organic EL element OEL to the light emission drive current Iel running across the anode and cathode of the organic EL element OEL is indicated by a characteristic curve SP0 in FIG. 10B.

In the initial condition where the electric characteristic of the organic EL element OEL is indicated by the characteristic curve SP0, a current of I₀ runs as the light emission drive current Iel across the anode and cathode of the organic EL element OEL and the organic EL element OEL emits light when the light emission drive voltage Vel across the anode and cathode of the organic EL element OEL is V₀.

Here, the electric characteristic (I-V characteristic) of the organic EL element varies with deterioration with time.

Specifically, as shown in FIG. 10B, the conduction resistance of the organic EL element OEL increases along with deterioration with time, and the initial characteristic curve SP0 thus changes in the direction of an arrow a in the graph into, for example, a characteristic curve SP1. The characteristic curve SP1 may represent a characteristic which has shifted in parallel toward a high-voltage side with respect to the characteristic curve SP0, or may otherwise represent a characteristic which has shifted toward the high-voltage side and which has changed in the inclination of the curve due to the increase of the resistance. FIG. 10B shows the latter case. In this case, if the potential difference Vel between the anode and cathode of the organic EL element OEL is V₀, the light emission drive current Iel running through the organic EL element OEL decreases ΔI from I₀ to a current I₁ (=I₀−ΔI), and the light emission luminance of the organic EL element OEL decreases.

Thus, in order for the value of the light emission drive current Iel running through the organic EL element OEL to be the same I₀ as the value in the initial condition, the light emission drive voltage Vel across the anode and cathode of the organic EL element OEL has to be set at V₁ (V₁=V₀+ΔV) which is higher than V₀, as shown in FIG. 10E.

Now, the change of the operation state in the equivalent circuit in FIG. 10A when the electric characteristic of the organic EL element has changed as shown in FIG. 10B is described with reference to FIG. 105.

In FIG. 105, the horizontal axis indicates a voltage (drain-source voltage) Vds across the drain and source of the transistor Tr13 and the light emission drive voltage Vel, and the vertical axis indicates a current (drain-source current) Ids running across the drain and source of the transistor Tr13 and the light emission drive current Iel. Here, the drain-source voltage Vds and the light emission drive voltage Vel have a relation of Equation (1), and the drain-source current Ids and the light emission drive current Iel have a relation of Equation (2).

Vds+Vel=Vsa−Vc (1)

Ids=Iel (2)

In FIG. 10C, the characteristic curves SP0, SP1 are equal to the characteristic curves SP0, SP1 shown in FIG. 10B. However, the characteristic curves SP0, SP1 in FIG. 10C are plotted laterally opposite to the characteristic curves SP0, SP1 in FIG. 10B in accordance with the relation in Equation (1).

A characteristic line ST0 indicates the characteristic of the transistor Tr13 representing the relation of the drain-source current. Ids to the drain-source voltage Vds when a gate voltage Vg of the transistor Tr13 from the data line Ld is set at the gradation voltage Vdata having a voltage value corresponding to image data. The transistor Tr13 is configured to operate in a linear region, and the characteristic line ST0 is generally a straight line which increases in proportion to the drain-source voltage Vds.

In FIG. 10C, when the organic EL element OEL has the electric characteristic indicated by the characteristic curve SP0, the operating point of the transistor Tr13 is PM0 which is the intersection of the characteristic curve SP0 and the characteristic line ST0. The light emission drive voltage Vel is Vel0, and the light emission drive current Iel is Iel0.

When the resistance of the organic EL element OEL increases along with deterioration with time and the characteristic curve changes from SP0 to SP1, the operating point of the transistor Tr13 is PM1 which is the intersection of the characteristic curve SP1 and the characteristic line ST0. The light emission drive voltage Vel is Vel1, and the light emission drive current Iel is Iel1. As shown in FIG. 10C, the light emission drive current fell has a value lower than Iel0, and the light emission luminance decreases.

A characteristic line ST1 indicates the characteristic when the gate voltage Vg of the transistor Tr13 is set at the gradation voltage (correction gradation voltage) Vdata having a voltage value corrected in accordance with the correction amount based on the acquired luminance compensation data.

When the resistance of the organic EL element OEL increases along with deterioration with time so that the characteristic curve reaches SP1 and the characteristic of the transistor Tr13 is as indicated by the characteristic line ST1, the operating point of the transistor Tr13 is PM2 which is the intersection of the characteristic curve SP1 and the characteristic line ST1. The light emission drive voltage Vel is Vel2, and the light emission drive current Iel is Iel2. The value of a correction amount is properly set, and the value of the gradation voltage Vdata is set accordingly so that the light emission drive current Iel2 may have a value equal to Iel0 or substantially the same value as Iel0. This suppresses the decrease of the light emission luminance even if the resistance of the organic EL element OEL increases along with deterioration with time.

In the luminance compensation data acquiring operation according to the present embodiment, the particular reference voltage Vmeas is applied to the contact N12 (anode of the organic EL element OEL) of the pixel PIX through the data line Ld. Thereby, the current Imeas running in accordance with the potential difference produced between the anode and cathode of the organic EL element OEL is measured by the ammeter 146c.

Furthermore, the current Imeas (luminance compensation data) converted into digital data is stored in the memory 148 in association with each pixel PIX.

Here, when the reference voltage Vmeas is changed and the current Imeas is thus measured for each pixel PIX more than one time, the luminance compensation data (current Imeas) is stored in the memory 148 in association with the reference voltage Vmeas.

Thus, the relation between the luminance compensation data (current Imeas converted into digital data) acquired for each pixel PIX and the reference voltage Vmeas corresponds to an I-V characteristic in the characteristic curves SP0, SP1 shown in FIG. 10B.

That is, when the luminance compensation data acquiring operation is performed in the initial condition of the organic EL element OEL, the voltage value V₀, for example, is applied to the pixel PIX as the reference voltage Vmeas. Suppose that the value of the current Imeas measured by the ammeter 146c in this case is I₀.

The luminance compensation data acquiring operation is then performed again. In this case, the voltage value V₀ is applied to the pixel PIX as the reference voltage Vmeas in the same mariner as described above. If the value of the current Imeas is I₁, it can be judged that the characteristic curve of the organic EL element OEL has changed from SP0 to SP1.

The characteristic curve SP1 after such a characteristic change can be specified by the relation between particular (one) reference voltage Vmeas and the measured current Imeas.

One method that can be used to more precisely specify the characteristic curve 301 is to change the reference voltage Vmeas for each pixel PIX to measure the current Imeas more than one time as described above.

Then, in the later-described display operation, as shown in FIG. 100, a correction amount for the gradation voltage Vdata to obtain a current value equal to or substantially equal to the light emission drive current Iel0 in the characteristic curve SP0 in the initial condition is extracted in accordance with the characteristic curve (I-V characteristic of the organic EL element OEL) SP1 specified by the relation between the reference voltage Vmeas and the current Imeas. The image data D0 to Dm are corrected by the correction operating circuit 144 in accordance with this correction amount.

That is, this correction amount is a value for correcting the value of the gradation voltage Vdata so that the light emission drive voltage Vel applied across the anode and cathode of the organic EL element OEL may be, for example, V₁ (V₁=V₀+ΔV). The correction amount is extracted in accordance with, for example, the acquired value of the luminance compensation data and the characteristic of the transistor Tr13, as shown in FIG. 10C.

If the gradation voltage Vdata having the corrected voltage value is written into the pixel PIX, the light emission drive current Iel0 having the original value corresponding to the image data can be passed through the organic EL element OEL through the transistor Tr13 of the pixel drive circuit DC, as shown in FIG. 10C.

Now, the above-mentioned luminance compensation data acquiring operation when performed in the display panel 110 in which the pixels PIP are two-dimensionally arranged is described.

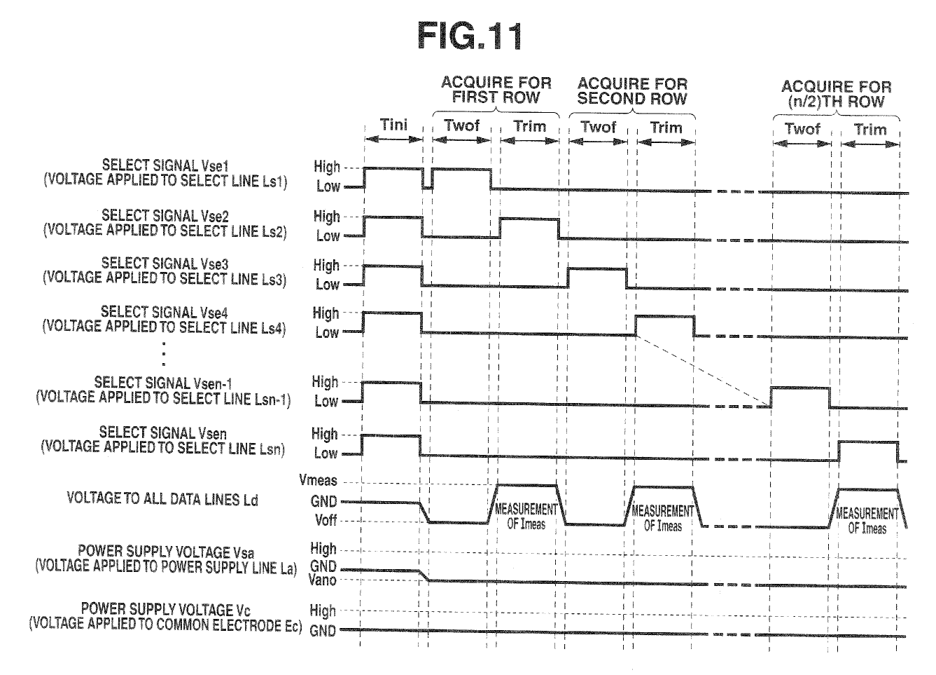

FIG. 11 is a timing chart in the case where the luminance compensation data acquiring operation according to the first embodiment is applied to the display panel in which the pixels are two-dimensionally arranged.

When the luminance compensation data acquiring operation is performed in the display panel 110 in which the pixels PIX are two-dimensionally arranged as has been shown in FIG. 2, the select driver 120 first simultaneously applies the high-level select signals Vse1 to Vsen to the select lines Ls1 to Lsn in all the rows in the display panel 110 in the initialization time Tini, as shown in FIG. 11.

Synchronously with this timing, the power supply driver 130 applies the power supply voltages Vsa and Vc having the ground potential GND to the power supply line La and the common electrode Ec.

In this condition, the data driver 140 sets the data line Ld in each column at the ground potential GND. As a result, the charge accumulated in the capacitor Cs of the pixel drive circuit DC and the charge remaining in each data line Ld are discharged in all the pixels PIX arranged in the display panel 110, thereby achieving initialization.

Then, as shown in FIG. 11, a series of operations comprising a Voff writing operation (Voff writing time Twof) and the current measuring operation (current measurement time Trim) is sequentially performed for the pixels PIX in the first row to n/2nd row of the display panel 110.

First, as described above, in the Voff writing time Twof, the select driver 120 applies, for the pixel PIX in the first row, the high-level select signal Vse1 to the select lines Ls1 and also applies the low-level select signals Vse2 to Vsen to the select lines Ls2 to Lsn.

Moreover, the power supply driver 130 applies the power supply voltage Vsa (=Vano) having a potential lower than the ground potential GND to the power supply line La, and also applies the power supply voltage Vc having the ground potential GND to the common electrode Ec.

In this condition, the data driver 140 simultaneously applies the elf-voltage Voff having a potential lower than the ground potential GND to the data line Ld in each row.

As a result, in the pixel PIX in the first row, the transistor Tr13 of the pixel drive circuit DC fully turns off.

Then, in the current measurement time Trim, the select driver 120 applies the low-level select signals Vse1, Vse3 to Vsen to the select lines Ls1, Ls3 to Lsn, and also applies the high-level select signal Vse2 to the select line Ls2.

In this condition, the data driver 140 simultaneously applies the particular reference voltage Vmeas to the data line Ld in each row.

As a result, in the pixel PIX in the first row, the current Imeas corresponding to the reference voltage Vmeas runs through the organic EL element OEL.

The value of the current Imeas is independently measured by the ammeter 146c connected to each data line Ld, thereby acquiring luminance compensation data (digitally converted current Imeas) for compensating for the variation in the light emission characteristic of the organic EL element OEL of each pixel PIX.

The acquired luminance compensation data is stored in the memory comprising a storage area corresponding to each pixel PIX.

Then, a series of operations comprising the Voff writing operation and current measuring operation described above is sequentially repeated for the pixel PIX in the n/2nd row of the display panel 110. Consequently, luminance compensation data is acquired for all the pixels PIX arranged in the display panel 110.

In the case described in the present embodiment, before the Voff writing operation and current measuring operation for the pixel PIX in each row are per as the luminance compensation data acquiring operation, the initializing operation is performed one time for all the pixels PIX.

The present invention is not limited to this. The initializing operation may be performed every time the Voff writing operation and current measuring operation for the pixel PIX in each row are performed.

In this way, a series of operations comprising the initializing operation, the Voff writing operation and the current measuring operation is performed for each row. Therefore, even if a charge remains in the data line Ld or the pixel PIX in each row after the Voff writing operation and current measuring operation for the pixel PIX in a given row are performed, the remaining charge is eliminated by the initializing operation. Thus, when the Voff writing operation and current measuring operation for the pixel PIX in the next row are performed, the influence of the previous remaining charge can be suppressed or eliminated.

(Display Operation)

Now, the display operation in the display apparatus according to the present embodiment is described.

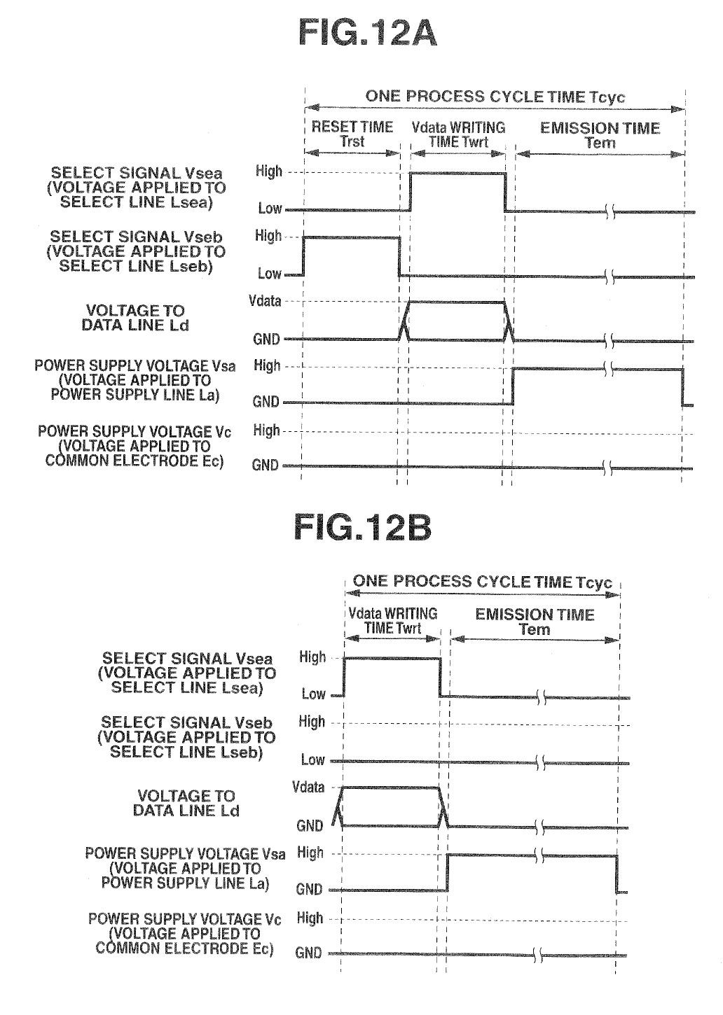

FIGS. 12A and 12B are timing charts showing the display operation in the display apparatus according to the present embodiment.

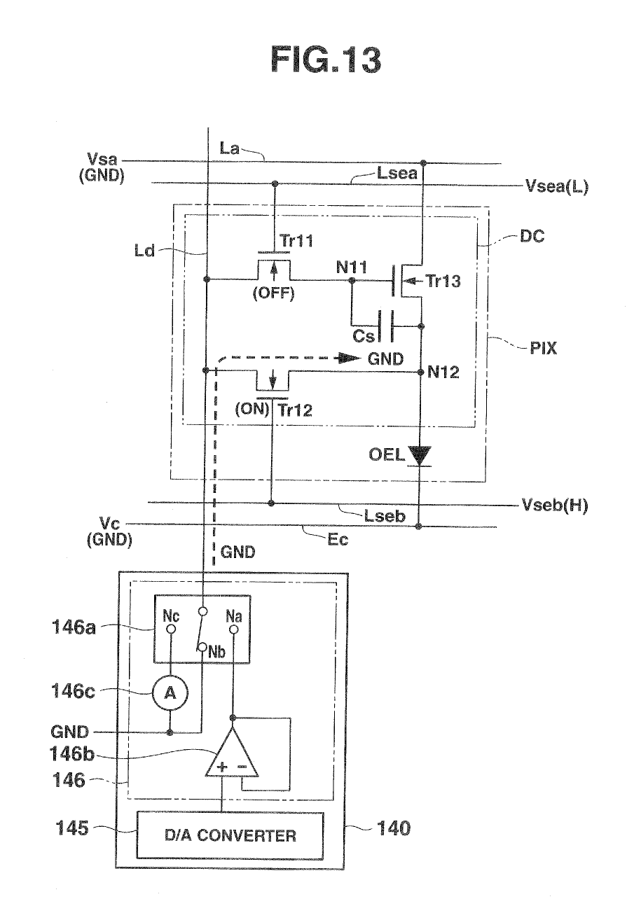

FIG. 13 is an operation concept diagram showing a reset, operation in the display apparatus according to the present embodiment.

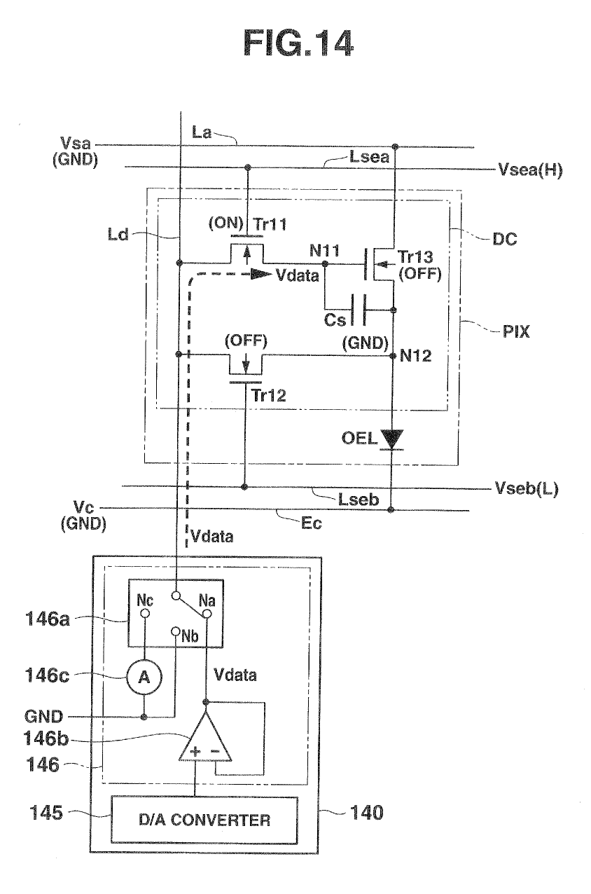

FIG. 14 is an operation concept diagram showing a gradation voltage writing operation in the display apparatus according to the present embodiment.

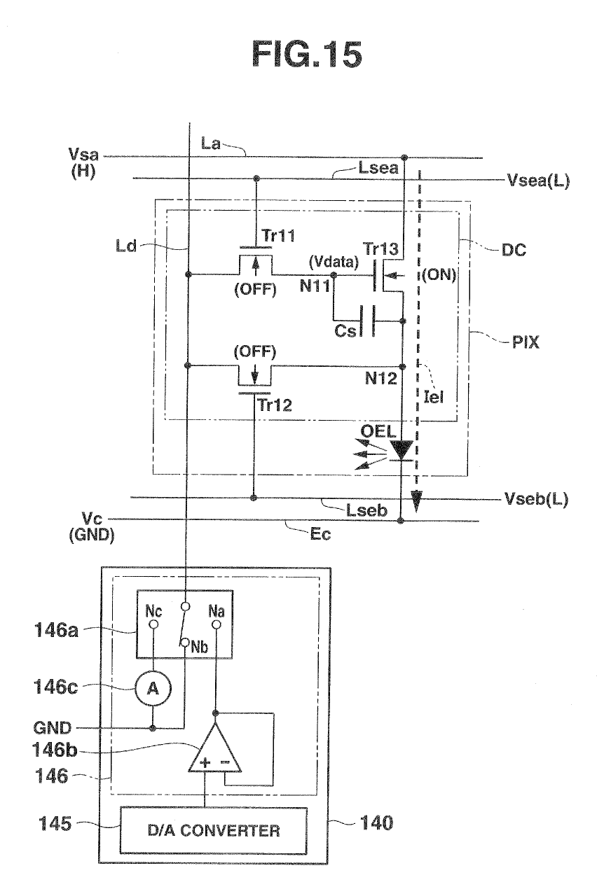

FIG. 15 is an operation concept diagram showing a light emission operation in the display apparatus according to the present embodiment.

Here, in FIG. 13 to FIG. 15, the D/A converter 145 and the output circuit 146 are only shown as the components of the data driver 140 for convenience of illustration.

The display operation according to the present embodiment is executed to have predetermined one process cycle time (display time) Tcyc shown in FIG. 12A. The one process cycle time Tcyc includes a reset time Trst for resetting the pixel PIX, a Vdata writing time Twrt for writing the gradation voltage Vdata corresponding to image data, and an emission time Tem for allowing the organic EL element OEL to emit light with a desired luminance gradation (Tcyc≧Trst+Twrt+Tem).

First, in the reset time Trst, the power supply driver 130 applies the power supply voltages Vsa and Vc at a low level (ground potential ONE) to the power supply line La and the common electrode Ec connected to the pixel PIX, as shown in FIG. 12A and FIG. 13.

Furthermore, the select driver 120 applies the select signal Vsea at a low level (unselect level) to the select line Lsea and also applies the select signal Vseb at a high level (select level) to the select line Lseb.

Synchronously with this timing, the data driver 140 switches/connects the changeover switch 146a provided in the output circuit 146 to the contact Nb and also switches/connects the changeover switch 146d to the contact Ng, thereby setting the data line Ld at the ground potential GND (reset voltage), as shown in FIG. 12A and FIG. 13.

Thus, as shown in FIG. 13, the transistor Tr12 provided in the pixel drive circuit DC of the pixel PIX turns on. Accordingly, the source terminal (contact N12; the anode of the organic EL element OEL) of the transistor Tr13 is set at the ground potential GND, and the drain terminal of the transistor Tr13 and the cathode of the organic EL element OEL are also set at the ground potential GND.

That is, the potential of the source terminal of the transistor Tr13 is reset to the ground potential GND.

At the same time, the transistor Tr13 turns off. No current runs through the organic EL element OEL, and the organic EL element OEL does not emit light.

It is not always necessary to perform the operation of resetting the potential of the source terminal of the transistor Tr13 to the ground potential GND by the reset time Trst.

That is, even if this operation is not performed, the operation in the next Vdata writing time Twrt can be performed without any problem in most cases. Therefore, in the one process cycle time Tcyc, no reset time Trst may be provided to perform no reset operation, for example, as in the timing chart shown in FIG. 12B.

However, if the potential of the source terminal of the transistor Tr13 is reset to the ground potential GND, this ensures that the transistor Tr13 can be turned off and that the organic EL element OEL can be in a non-emission state. Thus, this reset operation is preferably performed.

Next, in the Vdata writing time Twrt, the power supply driver 130 applies the power supply voltages Vsa and Vc at a low level (ground potential GND) to the power supply line La and the common electrode Ec, as shown iii FIG. 12A and FIG. 14.

Furthermore, the select driver 120 applies the select signal Vsea at a high level (select level) to the select line Lsea and also applies the select signal Vseb at a low level (unselect level) to the select line Lseb.

Synchronously with this timing, as shown in FIG. 12A and FIG. 14, the data driver 140 switches/connects the changeover switch 146a to the contact Na, thereby applying the gradation voltage Vdata corresponding to image data to the data line Ld.

Thus, as shown in FIG. 14, the transistor Tr11 provided in the pixel drive circuit DC of the pixel PIX turns on. Accordingly, the gradation voltage Vdata is applied to the gate electrode (contact N11) of the transistor Tr13.

Moreover, the transistor Tr12 turns off, and the ground potential GND applied to the source terminal (contact N12) of the transistor Tr13 is thus maintained.

The drain terminal of the transistor Tr13 and the cathode of the organic EL element OEL are set at the ground potential GND.

Thus, a charge corresponding to the gradation voltage Vdata is accumulated in the capacitor Cs connected between the gate and source of the transistor Tr13, and the gradation voltage Vdata is written into the pixel PIX.

At the same time, the transistor Tr13 turns on. However, no potential difference is produced between the source and drain, and no current therefore runs across the source and drain of the transistor Tr13. Accordingly, no current runs through the organic EL element OEL, and the organic EL element OEL does not emit light.

Here, the gradation voltage Vdata is set at a voltage value corrected in accordance with a correction amount extracted referring to a characteristic curve specified on the basis of the luminance compensation data which is acquired in the luminance compensation data acquiring operation and which is stored in the memory 148.

Specifically, the gradation voltage Vdata is corrected by the correction operating circuit 144 to such a voltage value that the light emission drive voltage Vel applied across the anode and cathode of the organic EL element OEL may be a voltage value V₁ (V₁=V₀+ΔV) in which a voltage component (corrected voltage component; corresponding to the voltage ΔV shown in FIG. 10B) that has been acquired by the luminance compensation data acquiring operation and that corresponds to the change amount of the light emission characteristic (I-V characteristic curve) of the organic EL element OEL of the pixel PIX is taken into account in a voltage component (corresponding to the voltage V₀ shown in FIG. 10B) generated in accordance with the luminance gradation value of the image data (correcting step). As a result, in the light emission operation described later, a current (light emission drive current) having a value to be originally supplied to the organic EL element OEL of the pixel PIX on the basis of the image data is generated by the transistor Tr13.

Next, in the emission time Tem, the select driver 120 applies the select signals Vsea and Vseb at a low level (unselect level) to the select lines Lsea and Lseb, as shown in FIG. 12A and FIG. 15.

Furthermore, the power supply driver 130 applies the high-level power supply voltage Vsa to the power supply line La and also applies the low-level power supply voltage Vc (ground potential GND) to the common electrode Ec.

Synchronously with this timing, the data driver 140 switches/connects the changeover switch 146a to the contact Nb and also switches/connects the changeover switch 146d to the contact Ng, thereby setting the data line Ld at the ground potential GND, as shown in FIG. 12A and FIG. 15.

Thus, as shown in FIG. 15, the transistors Tr11, Tr12 provided in the pixel drive circuit DC of the pixel PIX turn off, and the voltage Vdata applied to the gate terminal (contact N11) of the transistor Tr13 is maintained.

Furthermore, the high-level power supply voltage Vsa is applied to the drain terminal of the transistor Tr13, and the low-level power supply voltage Vc is applied to the cathode of the organic EL element OEL.

Thus, the voltage across the gate and source of the transistor Tr13 is maintained by the voltage Vdata with which the capacitor Cs is charged, and the transistor Tr13 turns on accordingly.

Since a forward bias is applied to the organic EL element OEL, the light emission drive current Iel runs toward the common electrode Sc from the power supply line La through the transistor Tr13, the contact 512 and the organic EL element OEL. Here, the light emission drive current Iel is determined by the value of the gradation voltage Vdata which is written in the pixel PIX in the Vdata writing operation and which is maintained across the gate and source of the transistor Tr13. Therefore, the light emission drive current Iel has a current value which compensates for the change in the light emission characteristic of the organic EL element OEL and which is adapted to the original light emission luminance corresponding to the image data.

Consequently, the organic EL element OEL emits light with the original luminance gradation corresponding to the image data independently of the state of change in the light emission characteristic.

Now, the above-mentioned display operation performed in the display panel 110 in which the pixels PIX are two-dimensionally arranged is described.

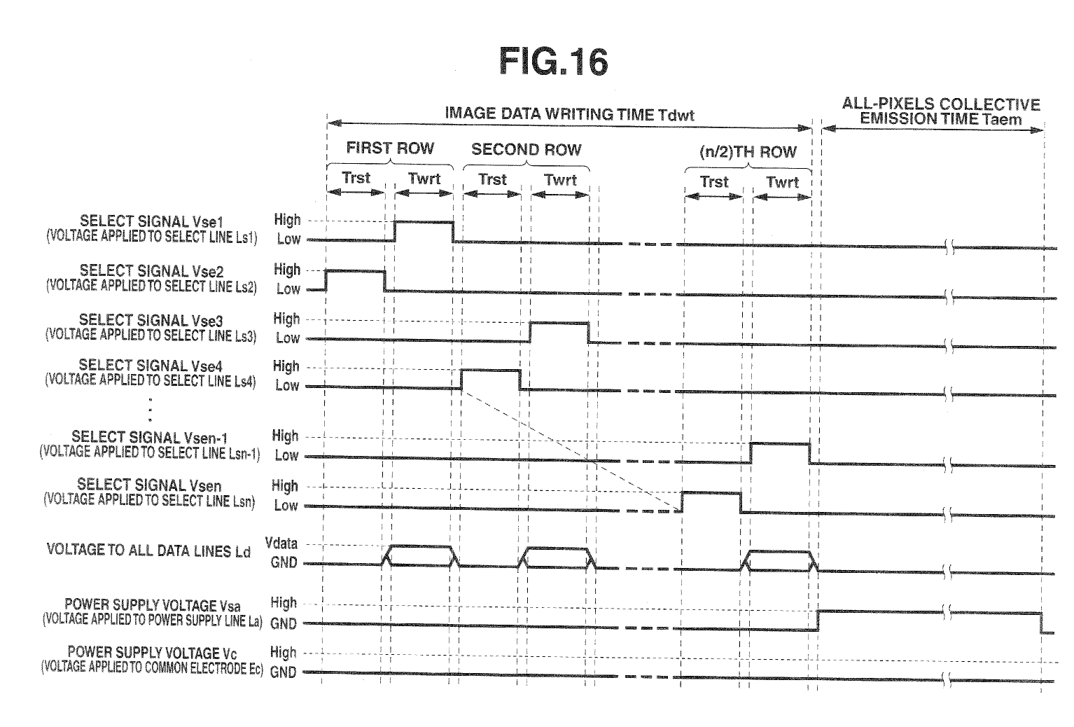

FIG. 16 is a timing chart in the case where the display operation according to the present embodiment is applied to the display panel in which the pixels are two-dimensionally arranged.

In order to perform the display operation in the display panel 110 shown in FIG. 2 in which the pixels PIX are two-dimensionally arranged, a series of operations comprising the reset operation and the Vdata writing operation is sequentially performed for the pixel PIX in the n/2nd row of the display panel 110 in an image data writing time Tdwt, as shown in FIG. 16.

First, in the reset time Trst, the select driver 120 applies the low-level select signals Vse1, Vse3 to Vsen to the select lines Ls1, Ls3 to Lsn, and also applies the high-level select signal Vse2 to the select line Ls2, as shown in FIG. 16.

Synchronously with this timing, the power supply driver 130 sets the power supply line La and the common electrode Er at the ground potential GND.

In this condition, the data driver 140 simultaneously sets the data lines Ld in the respective rows at the ground potential GND.

As a result, in each pixel PIX in the first row of the display panel 110, the potential of the contact N12 (the source terminal or the transistor Tr13 or the anode of the organic Et element OEL) of the pixel drive circuit DC is reset to the ground potential GND.

Then, in the Vdata writing time Twrt, the select driver 120 applies the high-level select signal Vse1 to the select lines Ls1 and also applies the low-level select signals Vse2 to Vsen to the select lines Ls2 to Lsn, as shown in FIG. 16.

In this condition, the data driver 140 applies, to the data line Ld in each row, the gradation voltage Vdata which corresponds to the image data and which has been corrected in accordance with the correction amount based on the luminance compensation data acquired by the luminance compensation data acquiring operation described above. As a result, in the pixel PIX in the first row, the capacitor Cs of the pixel drive circuit DC is filled with a charge corresponding to the gradation voltage Vdata, and the image data is written accordingly.

Then, as shown in FIG. 16, the series of operations for the pixel PIX in the first row described above is sequentially repeated for the pixels PIX in the second row to n/2nd row. Consequently, the gradation voltage Vdata which corresponds to the image data and which has been corrected in accordance with the correction amount based on the luminance compensation data acquired by the luminance compensation data acquiring operation described above is written into all the pixels PIX arranged in the display panel 110.

Furthermore, in an all-pixels collective emission time Teem, the select driver 120 applies the low-level select signals Vse1 to Vsen to the select lines Ls1 to Lsn, as shown in FIG. 16.

In this condition, the power supply driver 130 applies the high-level power supply voltage Vsa to the power supply line La and also applies the low-level power supply voltage Vc to the common electrode Ec.

Thus, in the pixels PIX in all the rows of the display panel 110, the light emission drive current Iel having a value corresponding to the gradation voltage Vdata runs through the transistor Tr13 which is a drive transistor of the pixel drive circuit DC. The organic EL element OEL in each pixel PIX emits light with the original luminance gradation corresponding to the image data. Consequently, desired image information is displayed on the display panel 110.

As described above, according to the display apparatus (light-emitting apparatus) and its drive control method of the present embodiment, the current Imeas adapted to the change in the light emission characteristic (I-V characteristic) of the organic EL element OEL which is a light-emitting element can be measured in a simple manner without a significant increase in the number of circuit elements such as the transistors provided in the pixel drive circuit DC of the pixel PIX. In this way, the luminance compensation data can be acquired for each pixel PIX.

Moreover, according to the display apparatus and its drive control method of the present embodiment, the gradation voltage Vdata which has been corrected in accordance with the change in the light emission characteristic of the organic EL element OEL provided in the pixel drive circuit DC can be written into each pixel PIX during writing of the image data into each pixel PIX.

As a result, the light emission drive current Iel having the original value corresponding to the image data can be passed through the organic EL element OEL independently of the state of characteristic change in the organic EL element OEL. Thus, the light-emitting apparatus allows the organic EL element OEL to emit light with a proper luminance gradation corresponding to the image data, so that high and uniform image quality can be obtained.

(Pixel Defect Detecting Method for Light-Emitting Apparatus)

Now, another example of the drive control method of the display apparatus according to the present embodiment is described with reference to the drawings.

In the drive control method described above, the luminance compensation data for compensating for the deterioration in the light emission characteristic of the organic EL element OEL (light-emitting element) is acquired in advance, and the gradation voltage Vdata is written into the pixel PIX after corrected in accordance with the luminance compensation data during the display operation.

The display apparatus (light-emitting apparatus) according to the present embodiment is not limited to this, and can also be applied to the case where a defect of the pixels PIX arranged in the light-emitting panel (display panel) is detected. Details are described below.

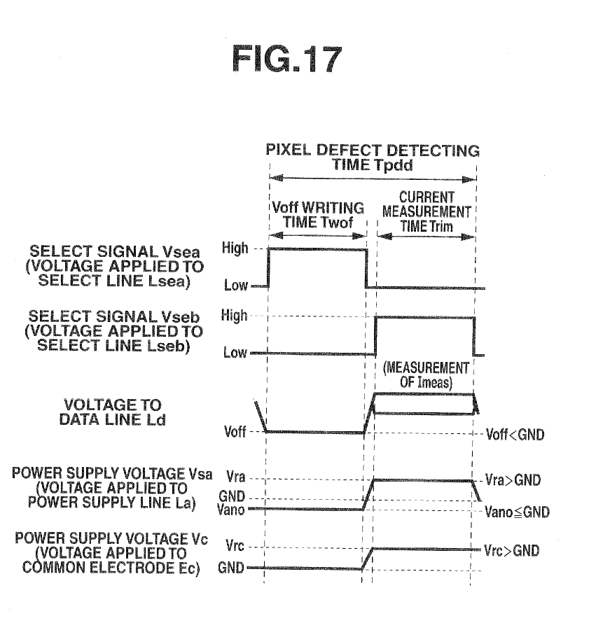

FIG. 17 is a timing chart showing a pixel defect detecting operation in the display apparatus according to the present embodiment.

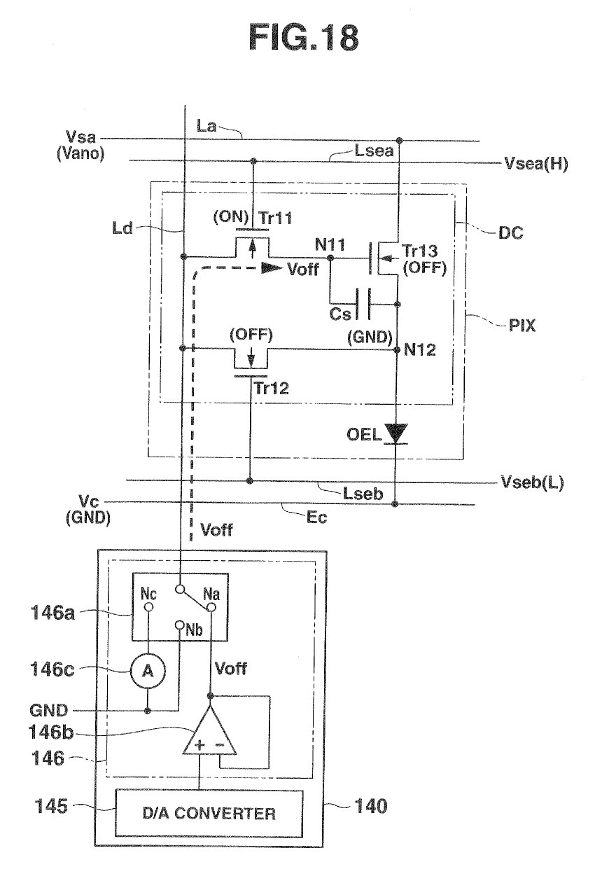

FIG. 18 is an operation concept diagram showing an off-voltage applying operation in the pixel defect detecting operation according to the present embodiment.

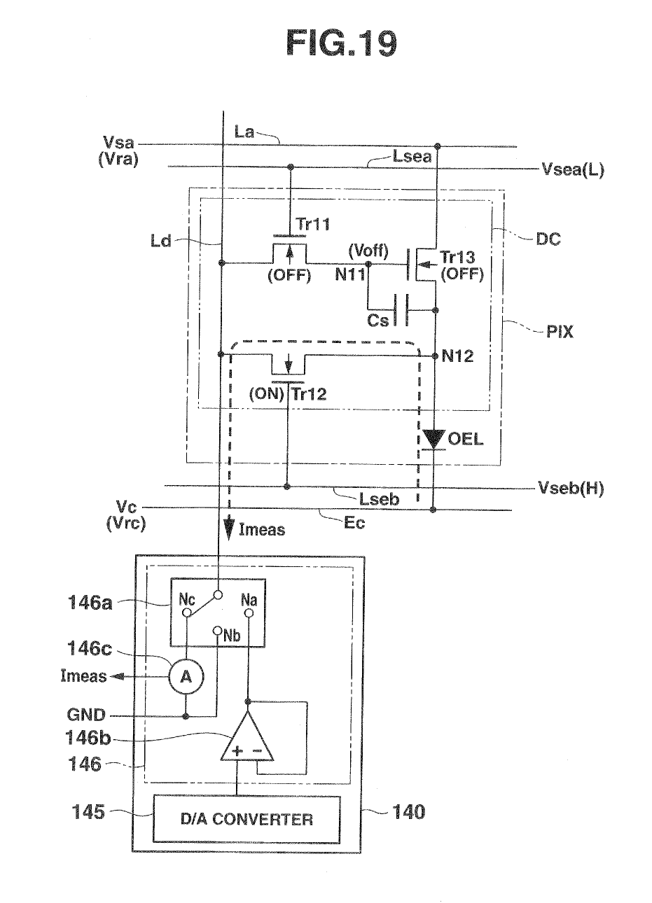

FIG. 19 is an operation concept diagram showing a current measuring operation in the pixel defect detecting operation according to the present embodiment.

Here, in FIG. 18 and FIG. 19, the D/A converter 145 and the output circuit 146 are only shown out of the data driver 140 shown in FIG. 4 for convenience of illustration.

In the output circuit 146, the changeover switch 146d is omitted, and a voltage supplied by switching/connection is only shown. Moreover, a control operation equivalent to the luminance compensation data acquiring operation described above is described in simplified manner.

In the pixel defect detecting operation according to the present embodiment, a parameter for detecting any deterioration in the element characteristic of each of the pixels PIX arranged in the display panel 110 is acquired.

More specifically, the following operation is performed: When a voltage to be a predetermined reverse bias is applied to the organic EL element OEL, the value of a leak current (current Imeas) running through the organic EL element OEL is measured as a parameter for extracting the degree (amount) of a change with time (deterioration with time) in the element characteristic of the organic EL element (light-emitting element) OEL provided in each pixel PIX. In accordance with the value of the leak current, whether the pixel is a defective pixel, is judged.

Specifically, the pixel defect detecting operation is executed to have a predetermined pixel defect detecting time Tpdd shown in FIG. 17. The pixel defect detecting time Tpdd includes at least the Voff writing time Twof and the current measurement time Trim.

In the Voff writing time Twof, the off-voltage Voff is written into the pixel PIX, as in the luminance compensation data acquiring operation described above.

In the current measurement time Trim, the current Imeas running through the pixel PIX (organic EL element OEL) is measured while a reverse bias voltage is being applied to the organic EL element OEL.

Although not shown in FIG. 17, a charge accumulated in the pixel PIX may be discharged to perform the initializing operation for initializing the pixel PIX before, the Voff writing time Twof, as in the luminance compensation data acquiring operation described above.

First, in the Voff writing time Twof, the power supply driver 130 applies the low-level power supply voltage Vsa (e.g., the voltage Vano having a potential lower than the ground potential GND) to the power supply line La and also applies the low-level power supply voltage Vc (e.g., the ground potential GND) to the common electrode Ec as shown in FIG. 17 and FIG. 18, as in the Voff writing operation in the luminance compensation data acquiring operation described above.

Furthermore, the select driver 120 applies the select signal Lsea at a high level (select level) to the select line Lsea and also applies the select signal Vseb at a low level (unselect level) to the select line Lseb.

Synchronously with this timing, as shown in FIG. 17 and FIG. 18, the data driver 140 switches/connects the changeover switch 146a to the contact Na, thereby applying the off-voltage Voff having a particular voltage value (e.g., a negative voltage value having a potential lower than the ground potential GND) to the data line Ld.

Thus, as shown in FIG. 18, the off-voltage Voff is applied to the gate terminal (contact N11) of the transistor Tr13 provided in the pixel drive circuit. DC of the pixel PIX. This ensures that the current path between the drain and source of the transistor Tr13 is closed.

Then, in the current measurement time Trim, the select driver 120 applies the select signal Vsea at a low level (unselect level) to the select line Lsea and also applies the select signal Vseb at a high level (select level) to the select line Lseb, as shown in FIG. 17 and FIG. 19.

Furthermore, the power supply driver 130 applies the high-level power supply voltage Vsa (e.g., a positive voltage Vra having a potential higher than the ground potential GND) to the power supply line La and also applies the high-level power supply voltage Vc (e.g., a positive voltage Vrc having a potential higher than the ground potential GND) to the common electrode Ec.

Synchronously with this timing, as shown in FIG. 17 and FIG. 19, the data driver 140 switches/connects the changeover switch 146a to the contact Nc and also switches/connects the changeover switch 146d to the contact Ng, thereby connecting one end, namely, a first end of the ammeter 146c to the data line Ld and setting the other end, namely, a second end at the ground potential GND.

Here, the power supply voltage Vc (=Vrc) applied to the common electrode Ec is set at a voltage having potential higher than the potential (e.g., the ground potential GND) set in the anode (contact N12) of the organic EL element OEL (Vrc>GND). Specifically, the power supply voltage Vc (=Vrc) is set at such a positive voltage value that the value of the current Imeas running to the data line Ld from the common electrode Ec through the organic EL element OEL and the transistor Tr12 can be measured by the ammeter 146c by setting the second end of the ammeter 146c at the ground potential GND.

Thus, as shown in FIG. 19, the transistor Tr11 provided in the pixel drive circuit DC of the pixel PIX turns off, and the off-voltage Voff applied to the gate terminal (contact N11) of the transistor Tr13 is maintained.

Furthermore, the transistor Tr12 turns on. Accordingly, the source terminal (contact N12) of the transistor Tr13 is connected to the first end of the ammeter 146c through the transistor Tr12 and the data line Ld. The drain terminal of the transistor Tr13 is set at the power supply voltage Vsa (=Vra) having a potential higher than the ground potential GNP.

Thus, a reverse bias condition is set in which a higher voltage is applied to the cathode side (common electrode Ec) of the organic EL element OEL than in the anode side (contact N12). Therefore, the minute leak current Imeas corresponding to the reverse bias voltage and the element characteristic of the organic EL element OEL runs through the organic EL element OEL in the reverse direction.

At the same time, the value of the current Imeas running to the data line Ld from the pixel PIX is measured by the ammeter 146c connected to the data line Ld.

The current Imeas measured by the series of pixel defect detecting operations described above is applied to a pixel defect judging process directly or after converted into digital data by, for example, the A/D converter 147 shown in FIG. 4.

The pixel defect judging process is executed in, for example, the system controller 150 shown in FIG. 1.

Specifically, in the pixel defect judging process, for example, the value of a leak current which runs when the above-mentioned particular reverse bias voltage is applied to the organic EL element OEL provided in the pixel PIX is first acquired as a stipulated value Ist by previous calculation through a simulation or the like based on the element structure of the organic EL element OEL or design data. Alternatively, the series of pixel defect detecting operations described above may be executed for the pixel. PIX provided with the organic EL element OEL having a normal characteristic. The value of the current Imeas thus measured may be acquired as the stipulated value Ist.

Then, the value of the current Imeas measured for a particular pixel PIX is compared with the current value of the stipulated value Ist. For example, when the measured value, of the current Imeas is relatively significantly higher than the current value of the stipulated value Ist, the pixel PIX having this organic EL element OEL is judged as a defective pixel (pixel defect judging step).

Here, in one example of an experiment conducted by the inventors, it has been found out that while a current value of a pA order is obtained as the stipulated value Ist, the measured current Imeas in the defective pixel shows a value of a μA order, and the value of the measured current Imeas in the defective pixel is about it 10⁵ to 10⁶ times the current value of the stipulated value Ist. Thus, for example, when the value of the measured current Imeas is about 10⁵ to 10⁶ times the current value of the stipulated value Ist, the relevant pixel PIX can be judged as a defective pixel.

Thus, according to the pixel defect detecting method for the display apparatus of the present embodiment, whether the relevant pixel PIX (organic EL element OEL) is a defective pixel can be judged in accordance with the current Imeas measured by a simple technique for the organic EL element OEL of each of the pixels PIX arranged in the display panel 110.

For example, when the number of pixels PIX judged as defective pixels causes trouble to the normal image display operation, or when deterioration of image quality is at such a level as strongly perceived by a user, the display panel can be judged as a rejected product at the inspection stage of the display apparatus, or replacement, repair or the like can be reported to the user of this display apparatus (or an electronic device incorporating the display apparatus).

### Second Embodiment

### Light-Emitting Apparatus

Now, a second embodiment of the display apparatus according to the present invention is described with reference to the drawings.

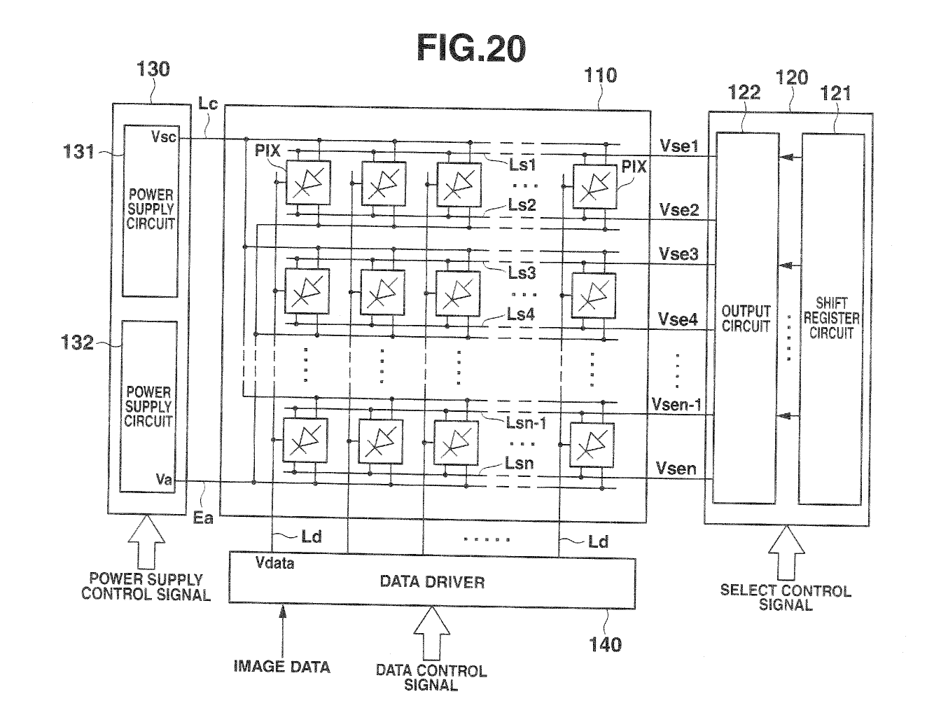

FIG. 20 is an essential configuration diagram showing one example of a display panel and its peripheral circuits (drive circuits) applied to the display apparatus according to the second embodiment.

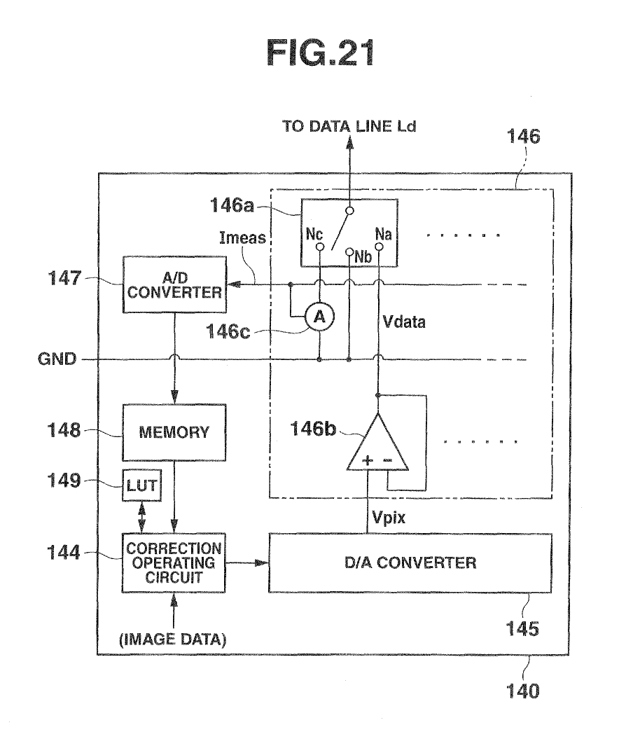

FIG. 21 is an essential configuration diagram showing one example of a data driver applied to the present embodiment.

Here, the overall configuration of the display apparatus is equivalent to that in the first embodiment (see FIG. 1) described above, and is not described.

In FIG. 21, a shift register circuit, a data register circuit and a data latch circuit of the data driver shown in FIG. 3 are omitted for simpler illustration.

Moreover, components equivalent to those in the first embodiment (see FIGS. 2 and 3) described above are simply described or not described.

A display panel 110 according to the present embodiment is provided with pixels PIX, select lines Ls1 to Lsn, a power supply line Lc, a common electrode Ea and data lines Ld, as shown in FIG. 20.

The pixels PIX, the select lines Ls1 to Lsn and the data lines Ld are similar in configuration to those in the first embodiment described above.

The power supply line Lc is provided so that this common power supply line Lc is connected to all the pixels PIX of the display panel 110.

The common electrode Ea is provided to be connected to all the pixels PIX of the display panel 110 in a shared manner, and comprises, for example, a single electrode layer (solid electrode).

A select driver 120 has a configuration similar to that in the first embodiment.

A power supply driver 130 is connected to the individual power supply line Lc which is connected to connected to the pixels PIX of the display panel 110 in a shared manner, and is also connected to the common electrode Ea.

The power supply driver 130 individually applies predetermined power supply voltages Vsc, Va to each power supply line Lc and the common electrode Ea by predetermined timing.

Here, for example, as shown in FIG. 20, the power supply driver 130 includes a power supply circuit 131 to supply the power supply voltage Vsc at a predetermined signal level to each power supply line Lc by predetermined timing and a power supply circuit 132 to supply the power supply voltage Va at a predetermined signal level to the common electrode Ea in accordance with a power supply control signal supplied from a system controller 150.

As in the first embodiment (see FIG. 3) described above, the data driver 140 includes a shift register circuit 141, a data register circuit 112, a data latch circuit 143, a correction operating circuit 144, a D/A converter 145, an output circuit 146, an A/D converter 147, a memory 148, and an LUT 149.

Here, as shown in FIG. 21, the output circuit 146 according to the present embodiment has a changeover switch 146a, a follower amplifier 146b and an ammeter 146c.

That is, in the configuration of the output circuit 146 according to the present embodiment, the changeover switch 146d shown in the output circuit 146 in the first embodiment (see FIG. 4) described above is omitted, and a contact Nb of the changeover switch 146a and a second end side of the ammeter 146c are always set at a ground potential GND.

Thus, to initialize or reset the pixels PIX arranged in the display panel 110, the data driver 140 (output circuit 146) connects the changeover switch 146a to the contact Nb, thereby setting the data line Ld at the ground potential GND.

To write image data into each pixel PIX, the data driver 140 (output circuit 146) connects the changeover switch 146a to a contact Na, thereby applying a gradation voltage Vdata corresponding to the image data to the data line Ld.

To acquire luminance compensation data for compensating for the light emission characteristic of each pixel PIX, the data driver 140 (output circuit 146) connects the changeover switch 146a to a contact Nc so that the value of a current Imeas running through the data line Ld is measured by the ammeter 146c.

(Pixels)

Now, the pixels arranged in the display panel according to the present embodiment are described in detail.

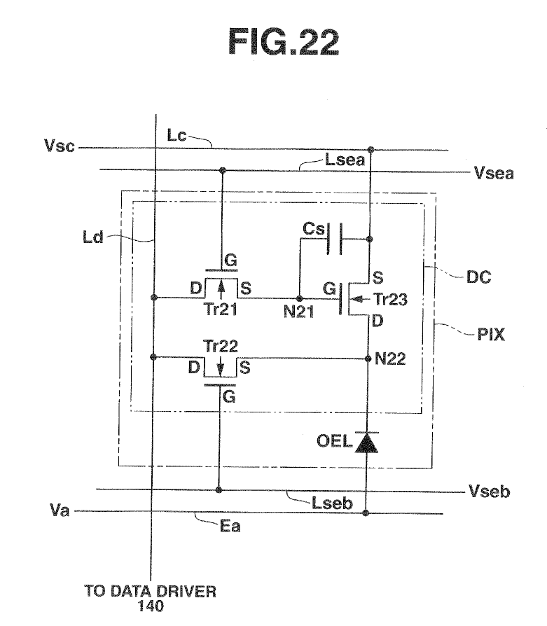

FIG. 22 is a circuit configuration diagram showing one embodiment of a pixel (a pixel drive circuit and a light-emitting element) applied to the display panel according to the present embodiment.

Here, components equivalent to those in the first embodiment (see FIG. 5) described above are provided with the same sings, and simply described or not described.

As shown in FIG. 22, each of the pixels PIX arranged in the display panel 110 according to the present embodiment includes a pixel drive circuit DC and an organic EL element (current-driven light-emitting element) OEL, as in the first embodiment (see FIG. 5) described above.

Specifically, the pixel drive circuit DC includes transistors Tr21 to Tr23 and a capacitor Cs.

The transistor Tr21 has its gate terminal connected to a select line Lsea (Ls1, Ls3, . . . , and Lsn1), its drain terminal connected to the data line Ld, and its source terminal connected to a contact N21

The transistor Tr22 (switching element) has its gate terminal connected to a select line Lseb (Ls2, Ls4, . . . , and Lsn), its drain terminal connected to the data line Ld, and its source terminal connected to a contact N22.

The transistor Tr23 (drive transistor) has its gate terminal connected to the contact N21, its source terminal connected to the power supply line Lc, and its drain terminal connected to the contact N22.

The capacitor Cs (storage capacitance) is connected between the gate terminal (contact N21) and source terminal of the transistor Tr23.

The organic EL element OEL has its anode (anode electrode) connected to the common electrode Ea, and its cathode (cathode electrode) connected to the contact N22 of the pixel drive circuit DC.

(Drive Control Method of Light-Emitting Apparatus)

Now, a drive control method of the display apparatus according to the present embodiment is described.

The drive control operation of the display apparatus 100 according to the present embodiment also includes at least a luminance compensation data acquiring operation and a display operation, similarly to the drive control operation of the display apparatus 100 according to the first embodiment described above.

Each operation is described in detail below.

(Luminance Compensation Data Acquiring Operation)

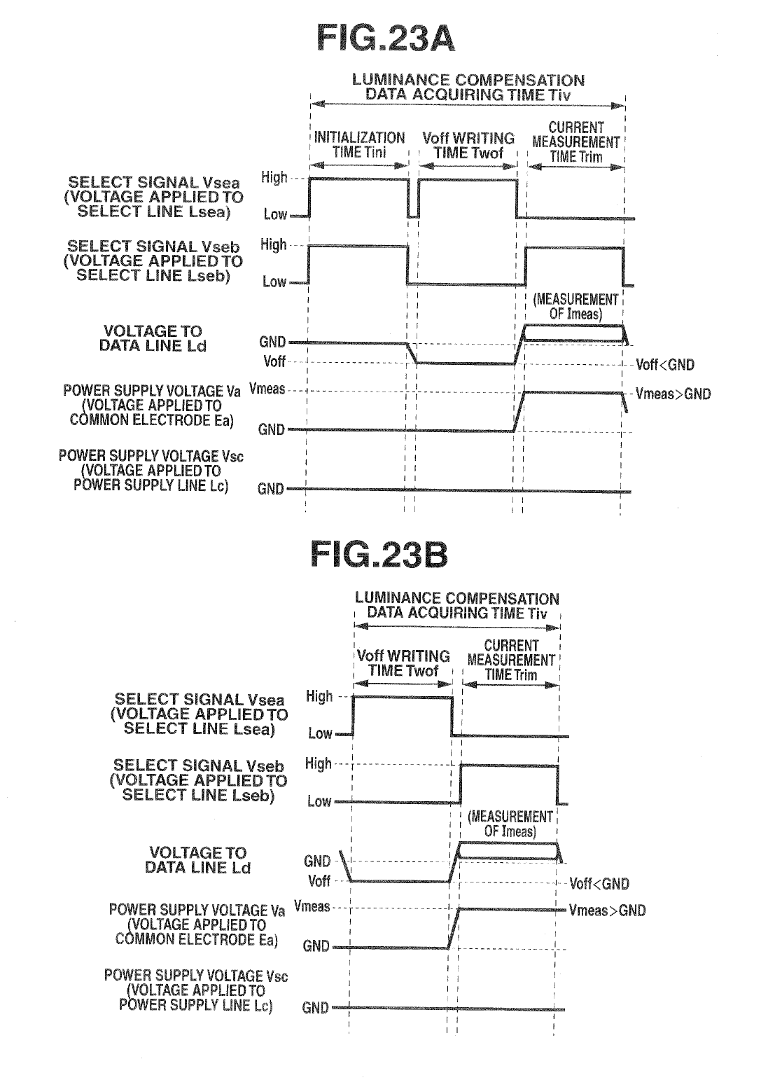

FIGS. 23A and 235 are timing charts showing the luminance compensation data acquiring operation in the display apparatus according to the present embodiment.

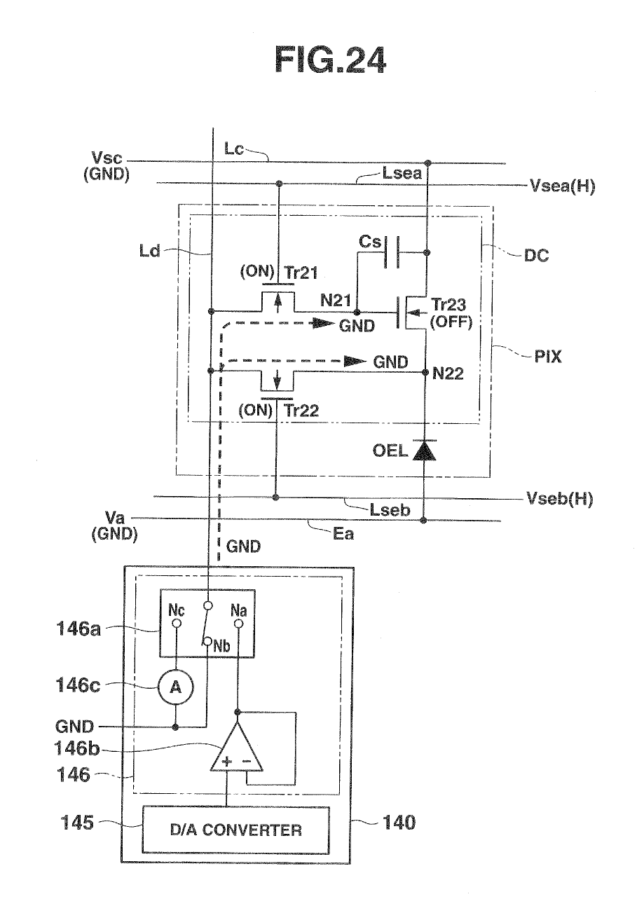

FIG. 24 is an operation concept diagram showing an initializing operation in the display apparatus according to the present embodiment.

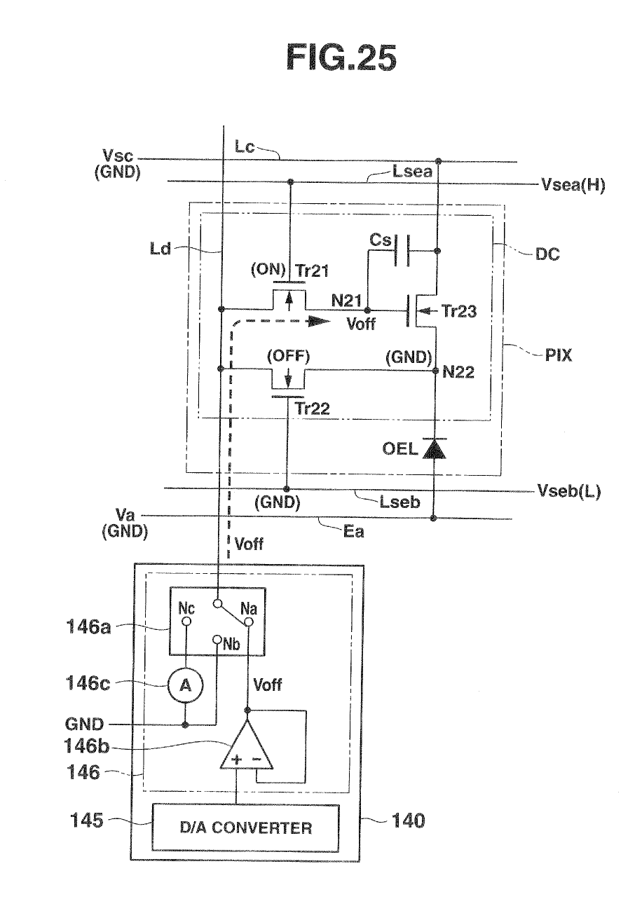

FIG. 25 is an operation concept diagram showing an off-voltage applying operation in the display apparatus according to the present embodiment.

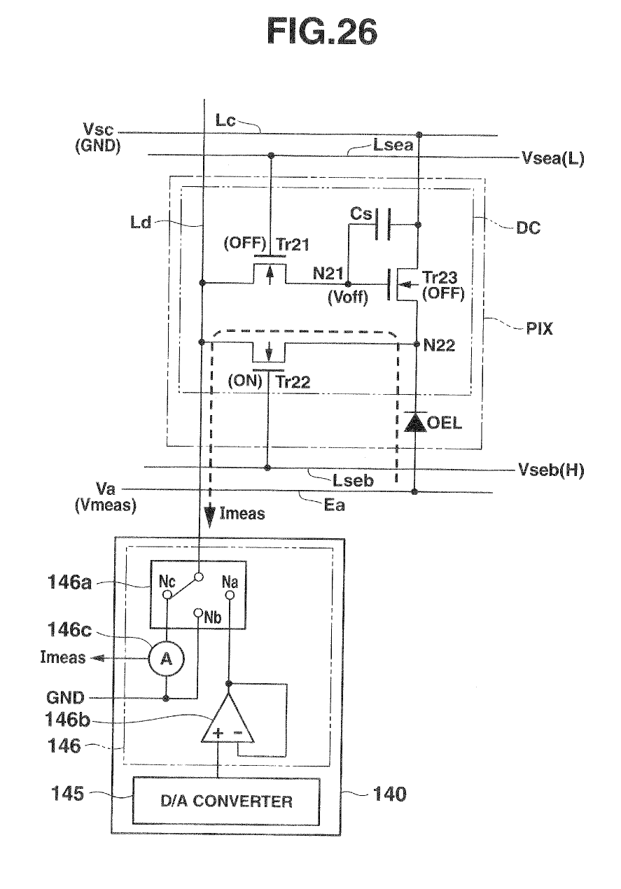

FIG. 26 is an operation concept diagram showing a current measuring operation in the display apparatus according to the present embodiment.

Here, in FIG. 24 to FIG. 26, the D/A converter 145 and the output circuit 146 are only shown as the components of the data driver 140 for convenience of illustration.

The luminance compensation data acquiring operation according to the present embodiment is performed to have a luminance compensation data acquiring time Tiv as shown in FIG. 23A, as in the first embodiment (see FIG. 6A) described above. The luminance compensation data acquiring time Tiv includes an initialization time Tini, a Voff writing time Twof and a current measurement time Trim.

First, in the initialization time Tini, the select driver 120 applies select signals Vsea and Vseb at a high level (select level) to the select lines Lsea and Lseb, as shown in FIG. 23A and FIG. 21.

Furthermore, the power supply driver 130 (power supply circuits 131, 132) applies the power supply voltages Vsc and Va at a low level (e.g., ground potential GND) to the power supply line Lc and the common electrode Ea.

Synchronously with this timing, the data driver 140 switches/connects the changeover switch 146a of the output circuit 146 to the contact Nb, thereby setting the data line Ld at the ground potential GND (initialization voltage), as shown in FIG. 23A and FIG. 24.

Thus, as shown in FIG. 24, the transistors Tr21 and Tr22 provided in the pixel drive circuit DC of the pixel PIX turn on. Accordingly, the gate terminal (contact N21) and drain terminal (contact N22; the cathode of the organic EL element OEL) of the transistor Tr23 are set at the ground potential GND, and the source terminal of the transistor Tr23 and the anode of the organic EL element OEL are also set at the ground potential GND.

As a result, the charge accumulated in the capacitor Cs connected between the gate and source of the transistor Tr23 and the charge remaining in the data line Ld are discharged, and the pixel PIX and the data line Ld are initialized (initialization step). At the same time, the transistor Tr23 turns off. No current runs through the organic EL element OEL, and the organic EL element OEL does not emit light.

As in the first embodiment (see FIGS. 6A and 6B) described above, it is not always necessary to perform the operation of turning on the transistor Tr22 to set the drain terminal of the transistor Tr23 at the ground potential GND in accordance with the initialization time Tini shown in FIG. 23A.

That is, even if this operation is not performed, the pixel PIX can be initialized without any problem in most cases. Therefore, in the luminance compensation data acquiring time Tiv, no initialization time Tini may be provided to perform no initializing operation, for example, as in the timing chart shown in FIG. 23E.

However, if the transistor Tr22 is turned on to set the drain terminal of the transistor Tr23 at the ground potential GND, this ensures that the charge accumulated in the capacitor Cs is discharged and the pixel PIX can be thus initialized. Therefore, the above-mentioned initializing operation is preferably performed.

Next, in the Voff writing Lime Twof, the power supply driver 130 applies the power supply voltages Vsc and Va at a low level (e.g., ground potential GND) to the power supply line Lc and the common electrode Ea as shown in FIG. 23A and FIG. 25, as in the initialization time Tini described above.

Furthermore, the select driver 120 applies the select signal Vsea at a high level (select level) to the select line Lsea and also applies the select signal Vseb at a low level (unselect level) to the select line Lseb.

Synchronously with this timing, as shown in FIG. 23A and FIG. 25, the data driver 140 switches/connects the changeover switch 146a to the contact Na, thereby applying an off-voltage Voff having a particular voltage value to the data line Ld (off-voltage a step).

Here, the off-voltage Voff applied to the gate electrode (contact N21) of the transistor Tr23 of the pixel PIX is set at a voltage value that can fully turn off the transistor Tr23 of the pixel drive circuit DC, as in the first embodiment described above. Specifically, the off-voltage Voff is set at a voltage value sufficiently lower than the power supply voltages Vsc applied to the source terminal of the transistor Tr23, for example, at a negative voltage value having a potential lower than the ground potential GND.

As a result, the transistor Tr21 turns on, and the off-voltage Voff is thus applied to the gate terminal (contact N21) of the transistor Tr23, as shown in FIG. 25.

Moreover, the transistor Tr22 turns off, and the potential (GND) of the drain terminal (contact N22) of the transistor Tr23 is thus maintained.

The source terminal of the transistor Tr23 and the anode of the organic EL element OEL are set at the ground potential GND.

That is, the gate electrode (contact N21) of the transistor Tr23 is set at a potential sufficiently lower than the voltage (GND) of the source terminal by the voltage (Voff). The drain terminal (contact N22) is also set at the ground potential GND. This ensures that the current path between the cram and source of the transistor Tr23 is closed. Thus, even a minute leak current does not run to the transistor Tr23 and the organic EL element OEL (cutting step).

In the case shown according to the present embodiment, the potential of the low-level power supply voltage Vsc supplied to the power supply line Lc in the Voff writing time Twof is set at the ground potential GND. The present invention is not limited to this. The point of connection of the power supply circuit 131 of the power supply driver 130 to the power supply line Lc may be severed (the power supply line Lc may be opened) to set the power supply line Lc to a high-impedance state.

Furthermore, in the current measurement time Trim (characteristic measuring step), the select driver 120 applies the select signal Vsea at a low level (unselect level) to the select line Lsea and also applies the select signal Vseb at a high level (select level) to the select line Lseb, as shown in FIG. 23A and FIG. 26.

Furthermore, the power supply driver 130 applies the low-level power supply voltage Vsc (e.g., the ground potential GND) to the power supply line Lc and also applies the high-level power supply voltage Va (e.g., a reference voltage Vmeas having a potential higher than the ground potential GND) to the common electrode Ea.

Synchronously with this timing, as shown in FIG. 23A and FIG. 26, the data driver 140 switches/connects the changeover switch 146a to the contact Nc, thereby connecting the data line Ld to the first end side of the ammeter 146c (voltage applying step).

Here, the high-level power supply voltage Va (voltage Vmeas) applied to the common electrode Ea is set at a potential higher than the ground potential GNP which is set in the cathode of the organic EL element OEL (Vmeas>GND). As a result, a voltage to be a forward bias is applied to the organic EL element OEL.

Specifically, the reference voltage Vmeas is set at such a positive voltage value that the value of the current Imeas running to the data line Ld from the common electrode Ea through the organic EL element (DEL and the transistor Tr22 can be measured by the ammeter 146c by applying the ground potential GND to the data line Ld through the ammeter 146c. At the same time, the organic EL element OEL emits light with a luminance corresponding to the value of the current Imeas. When the value of the current Imeas is sufficiently low, the organic EL element OEL is in an almost non-emission state.

Thus, as shown in FIG. 26, the transistor Tr21 turns off, and the off-voltage Voff applied to the gate terminal (contact N21) of the transistor Tr23 is maintained.

Furthermore, the transistor Tr22 turns on. Accordingly, the drain terminal (contact N22) of the transistor Tr23 is connected to the ammeter 146c through the data line Ld, and a voltage (Vn22≈ground potential GND) based on the ground potential GND is applied to the drain terminal (contact N22; the cathode of the organic EL element OEL) through the ammeter 146c and the data line Ld (connecting step).

Moreover, the source terminal of the transistor Tr23 is set at the ground potential GND, and the anode of the organic EL element OEL is set at the voltage Vmeas having a potential higher than the ground potential GND.

Thus, the voltage Vmeas having a potential higher than the voltage on the cathode side (Vn22) is applied to the anode side of the organic EL element OEL. Accordingly, the current Imeas corresponding to the potential difference between the voltage Vmeas and the voltage (Vn22≈ground potential GND) and corresponding to the conduction resistance of the organic EL element OEL runs through the organic EL element OEL in a forward direction.

At she same time, the ammeter 116c connected to the data line Ld measures the value of the current Imeas running to the data line Ld through the organic EL element OEL from the common electrode Ea to which the voltage Vmeas is applied (current measuring step).

The value of the current Imeas measured by the ammeter 146c is converted into digital data by the A/D converter 147 shown in FIG. 21, and then stored in the memory 148 as the luminance compensation data. The memory 148 stores the luminance compensation data in association with the respective pixels PIX (compensation data storing step).

In the case shown according to the present embodiment, the value of the current Imeas which runs through the organic EL element OEL is measured only once in the current measurement time Trim. The present invention is not limited to this.

That is, for example, the voltages Vmeas having different voltage values may be applied to the common electrode Ea to measure the value of the current Imeas running through the organic EL element OEL at the moment more than one time (e.g., about two or three times). In this case, more than one current value can be obtained for each pixel PIX, and luminance compensation data based or these values is scored in the memory 148 in association with the respective pixels PIX.

The relation between the luminance compensation data (current Imeas converted into digital data) acquired for each pixel PIX by the luminance compensation data acquiring operation described above and the voltages Vmeas applied to the common electrode Ea corresponds to the I-V characteristic of the characteristic curves SP0, SP1 shown in FIG. 10B, as has been described in the first embodiment. Thus, a characteristic curve that indicates the light emission characteristic (I-V characteristic) of the organic EL element OEL is specified by the relation between particular (one or more) voltages Vmeas and the measured current Imeas.

Then, image data D0 to Dm are corrected by the correction operating circuit 144 in accordance with a correction amount based on the characteristic curve (I-V characteristic of the organic EL element OEL) specified for each pixel PIX in the later-described display operation. Thus, the gradation voltage Vdata written into each pixel PIX is corrected, and a light emission drive current Iel having the original value (value corresponding to the characteristic curve in the initial condition) corresponding to the image data runs through the organic EL element OEL.

Now, the above-mentioned luminance compensation data acquiring operation when performed in the display panel 110 in which the pixels PIX are two-dimensionally arranged is described.

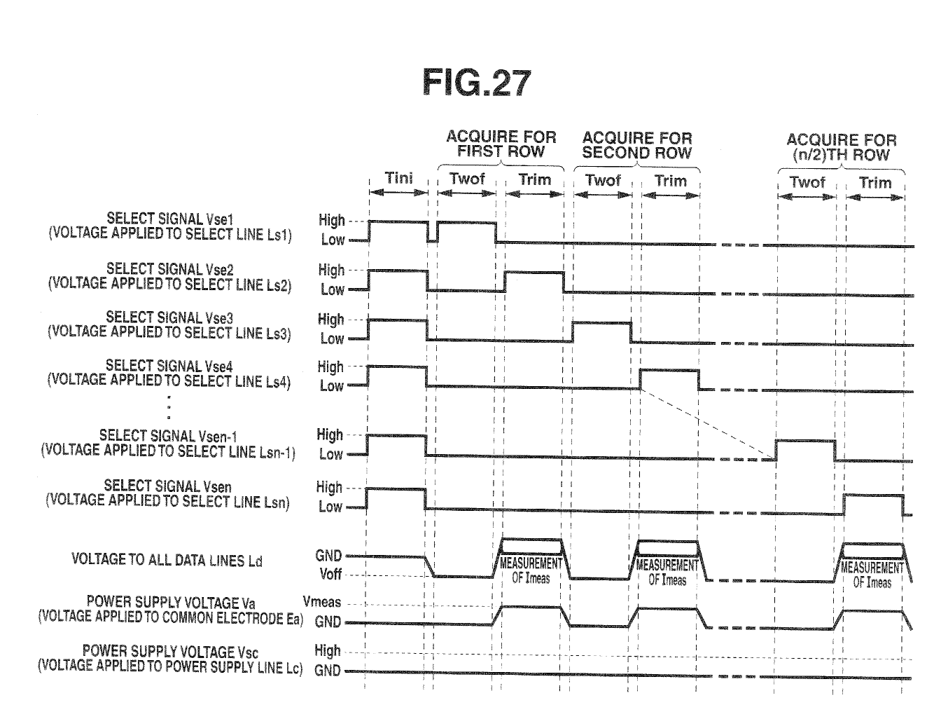

FIG. 27 is a timing chart in the case where the luminance compensation data acquiring operation according to the present embodiment is applied to the display panel in which the pixels are two-dimensionally arranged.

When the luminance compensation data acquiring operation is performed in the display panel 110 in which the pixels PIX are two-dimensionally arranged as has been shown in FIG. 20, the select driver 120 first simultaneously applies high-level select signals Vse1 to Vsen to the select lines Ls1 to Lsn in all the rows in the display panel 110 in the initialization time Tini, as shown in FIG. 27.

Synchronously with this timing, the power supply driver 130 applies the power supply voltages Vsc and Va having the ground potential GND to the power supply line Lc and the common electrode Ea.

In this condition, the data driver 140 sets the data line Ld in each column at the ground potential GND.

As a result, the charge accumulated in the capacitor Cs of the pixel drive circuit DC and the charge remaining in each data line Ld are discharged in all the pixels PIX arranged in the display panel 110, thereby achieving initialization.

Then, as shown in FIG. 27, a series of operations comprising a Voff writing operation (Voff writing time Twof) and the current measuring operation (current measurement time Trim) sequentially performed for the pixels PIX in the first row to n/2nd row of the display panel 110.

First, as described above, in the Voff writing time Twof, the select driver 120 applies, for the pixel PIX in the first row, the high-level select signal Vse1 to the select lines Ls1 and also applies the low-level select signals Vse2 to Vsen to the select Lines Ls2 to Lsn.

Moreover, the power supply driver 130 applies the power supply voltages Vsc and Va having the ground potential GND to the power supply line Lc and the common electrode Ea.

In this condition, the data driver 140 simultaneously applies the off-voltage Voff having a potential lower than the ground potential GND to the data line Ld in each row. As a result, in the pixel PIX in the first row, the transistor Tr23 of the pixel drive circuit DC fully turns off.

Then, in the current measurement time Trim, the select driver 120 applies the low-level select signals Vse1, Vse3 to Vsen to the select lines Ls1, Ls3 to ban, and also applies the high-level select signal Vse2 to the select line Ls2.

In this condition, the data driver 140 simultaneously sets the data lines Ld in the respective rows at the ground potential GND, and the power supply driver 130 (power supply circuit 132) applies the power supply voltage Va of the voltage Vmeas having a potential higher than the ground potential GND to the common electrode Ea. As a result, in the pixel PIX in the first row, the current Imeas corresponding to the voltage Vmeas runs through the organic EL element OEL.

The value of the current Imeas is independently measured by the ammeter 146c connected to each data line Ld, thereby acquiring luminance compensation data (digitally converted current Imeas) for compensating for the variation in the light emission characteristic of the organic EL element OEL of each pixel PIX.

The acquired luminance compensation data is stored in the memory comprising a storage area corresponding to each pixel PIX.

Then, the series of operation comprising the Voff writing operation and the current measuring operation is sequentially repeated for the pixels PIX in and after the second row. Consequently, luminance compensation data is acquired for all the pixels PIX arranged in the display panel 110.

In the present embodiment as well, the initializing operation may be performed every time before the Voff writing operation and current measuring operation for the pixel PIX in each row are performed.

In this way, the initializing operation is performed for each row. Therefore, even if a charge remains in the data line Ld or the pixel PIX in each row after the Voff writing operation and current measuring operation for the pixel PIX in a given row are performed, the remaining charge is eliminated by the initializing operation. Thus, when the Voff writing operation and current measuring operation for the pixel NIX in the next row are performed, the influence of the previous remaining charge can be suppressed or eliminated.

(Display Operation)

Now, the display operation in the display apparatus according to the present embodiment is described.

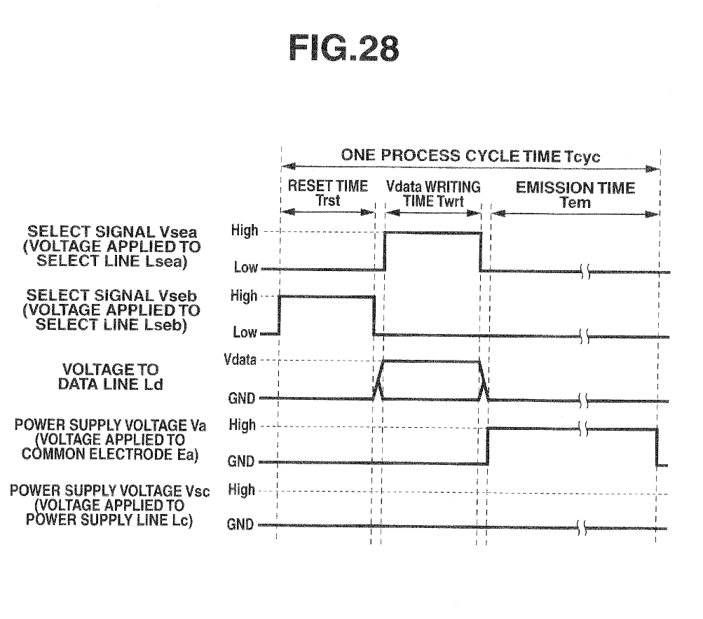

FIG. 28 is a timing chart showing the display operation in the display apparatus according to the present embodiment.

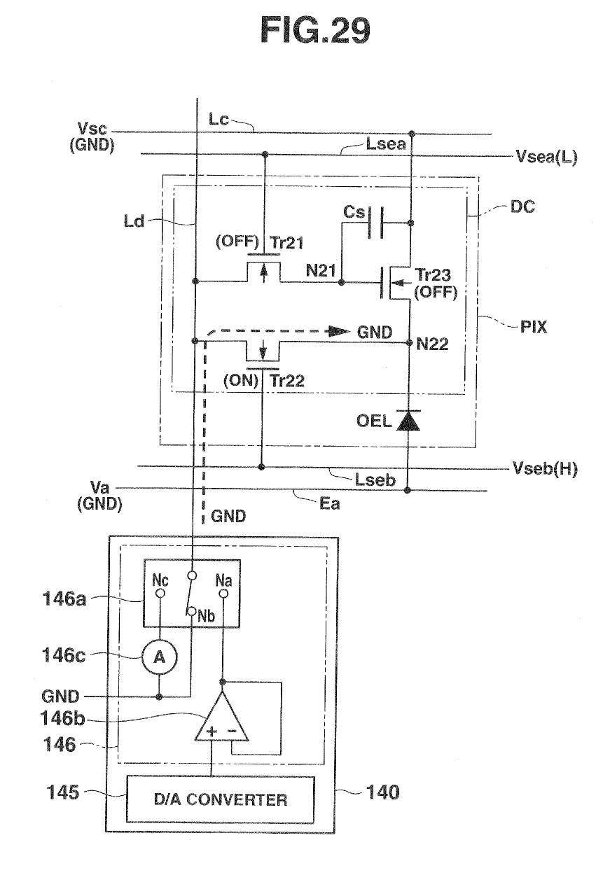

FIG. 29 is an operation concept diagram showing a reset operation in the display apparatus according to the present embodiment.

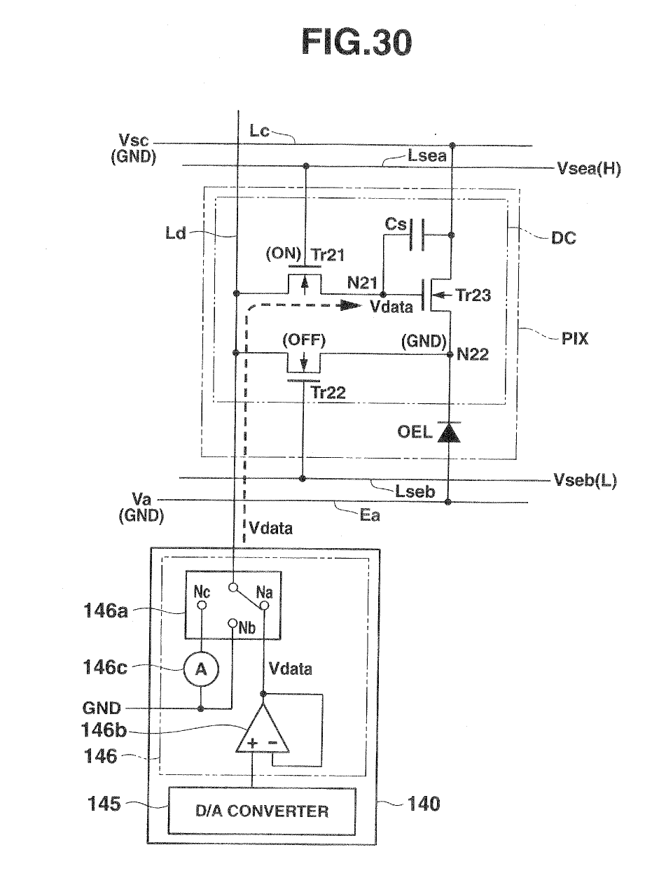

FIG. 30 is an operation concept diagram showing a gradation voltage writing operation in the display apparatus according to the present embodiment.

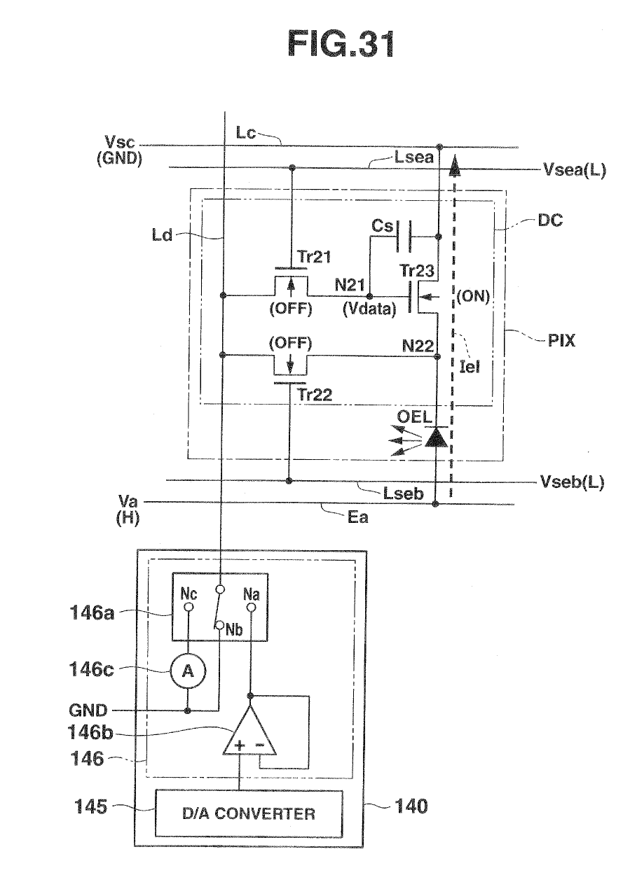

FIG. 31 is an operation concept diagram showing a light emission operation in the display apparatus according to the present embodiment.

Here, in FIG. 39 to FIG. 31, the D/A converter 145 and the output circuit 146 are only shown as the components of the data driver 140 for convenience of illustration. Moreover, the display operation equivalent to that in the first embodiment is simply described.

As in the first embodiment described above, the display operation according to the present embodiment is executed to have predetermined one process cycle time (display time) Tcyc as shown in FIG. 28. The one process cycle time Tcyc includes a reset time Trst, a Vdata writing time Twrt and an emission time Tem (Tcyc≧Trst+Twrt+Tem).

First, in the reset time Trst, the power supply driver 130 applies the power supply voltages Vsc and Va at a low level (ground potential GND) to the power supply line Lc and the common electrode Ea connected to the pixel PIX, as shown in FIG. 28 and FIG. 29.

Furthermore, the select driver 120 applies the select signal Vsea at a low level (unselect level) to the select line Lsea and also applies the select signal Vseb at a high level (select level) to the select line Lseb.

Synchronously with this timing, the data driver 140 switches/connects the changeover switch 146a provided in the output circuit 146 to the contact Nb, thereby setting the data line Ld at the ground potential GND (reset voltage), as shown in FIG. 28 and FIG. 29.

Thus, as shown in FIG. 29, the transistor Tr22 turns on. Accordingly, the drain terminal (contact N22; the cathode of the organic EL element OEL) of the transistor Tr23 is set at the ground potential GND, and the source terminal of the transistor Tr23 and the anode of the organic EL element OEL are also set at the ground potential GND.

At the same time, the transistor Tr23 turns off. No current runs through the organic EL element OEL, and the organic EL element OEL does not emit light.

Next, in the Vdata writing time Twrt, the power supply driver 130 applies the power supply voltages Vsc and Va at a low level (ground potential GND) to the power supply line Lc and the common electrode Na, as shown in FIG. 28 and FIG. 30.

Furthermore, the select driver 120 applies the select signal Vsea at a high level (select level) to the select line Lsea and also applies the select signal Vseb at a low level (unselect level) to the select line Lseb.

Synchronously with this timing, the data driver 140 switches/connects the changeover switch 146a to the contact Na, thereby applying the gradation voltage Vdata corresponding to image data to the data line Ld, as shown in FIG. 28 and FIG. 30.

Thus, as shown in FIG. 30, the transistor Tr21 provided in the pixel drive circuit DC of the pixel PIX turns on. Accordingly, the gradation voltage Vdata is applied to the gate electrode (contact N21) of the transistor Tr13.

Moreover, the transistor Tr22 turns off, and she ground potential GND applied to the drain terminal (contact N22) of the transistor Tr23 is thus maintained.

The source terminal of the transistor Tr23 and the anode of the organic EL element OEL are set at the ground potential GND.

Thus, a charge corresponding to the gradation voltage Vdata is accumulated in the capacitor Cs connected between the gate and source of the transistor Tr23, and the gradation voltage Vdata is written into the pixel PIX.

At the same time, the transistor Tr23 turns on. However, no potential difference is produced between the source and drain, and no current therefore runs across the source and drain of the transistor Tr23. Accordingly, no current runs through the organic EL element OEL, and the organic EL element OEL does not emit light.

Here, the gradation voltage Vdata is set at a voltage value corrected in accordance with a correction amount extracted referring to a characteristic curve specified on the basis of the luminance compensation data which is acquired in the luminance compensation data acquiring operation described above.

Specifically, as in the first embodiment described above, the gradation voltage Vdata is corrected by the correction operating circuit 144 to such a voltage value that a light emission drive, voltage Vel applied across the anode and cathode of the organic EL element OEL may be a voltage value in which a voltage component (corrected voltage component) that has been acquired by the luminance compensation data acquiring operation and that corresponds to the change amount of the light emission characteristic (I-V characteristic curve) of the organic EL element OEL is taken into account in a voltage component generated in accordance with the luminance gradation value of the image data (correcting step). As a result, in the light emission operation described later, a current (light emission drive current) having a value to be originally supplied to the organic EL element OEL of the pixel PIX on the basis of the image data is generated by the transistor Tr23.

Next, in the emission time Tem, the select, driver 120 applies the select signals Vsea and Vseb at a low level (unselect level) to the select lines Lsea and Lseb, as shown in FIG. 28 and FIG. 31.

Furthermore, the power supply driver 130 applies the high-level power supply voltage Va to the common electrode Ea and also applies the low-level power supply voltage Vsc (ground potential GND) to the power supply line Lc.

Synchronously with this timing, the data driver 140 switches/connects the changeover switch 146a to the contact Nb, thereby setting a data line Lda at the ground potential GND, as shown in FIG. 28 and FIG. 31.

Thus, as shown in FIG. 31, the transistors Tr21, Tr22 turn off, and the voltage Vdata applied to the gate terminal (contact N21) of the transistor Tr23 is maintained.

Furthermore, the low-level power supply voltage Vsc is applied to the source terminal of the transistor Tr23, and the high-level power supply voltage Va is applied to the anode of the organic EL element OEL.

Thus, the voltage across the gate and source of the transistor Tr23 is maintained by the voltage Vdata with which the capacitor Cs is charged, and the transistor Tr23 turns on accordingly.

Since a forward bias is applied to the organic EL element OEL, the light emission drive current Iel runs toward the power supply line Lc from the common electrode Ea through the organic EL element OEL, the contact N22 and the transistor Tr23. Here, the light emission drive current Iel is determined by the value of the gradation voltage Vdata which is written in the pixel PIX in the Vdata writing operation and which is maintained across the gate and source of the transistor Tr23. Therefore, the light emission drive current Iel has a current value which compensates for the change in the light emission characteristic of the organic EL element OEL and which is adapted to the original light emission luminance corresponding to the image data.

Consequently, the organic EL element OEL emits light with the original luminance gradation corresponding to the image data independently of the state of change in the light emission characteristic.

Now, the above-mentioned display operation performed in the display panel 110 in which the pixels PIX are two-dimensionally arranged is described.

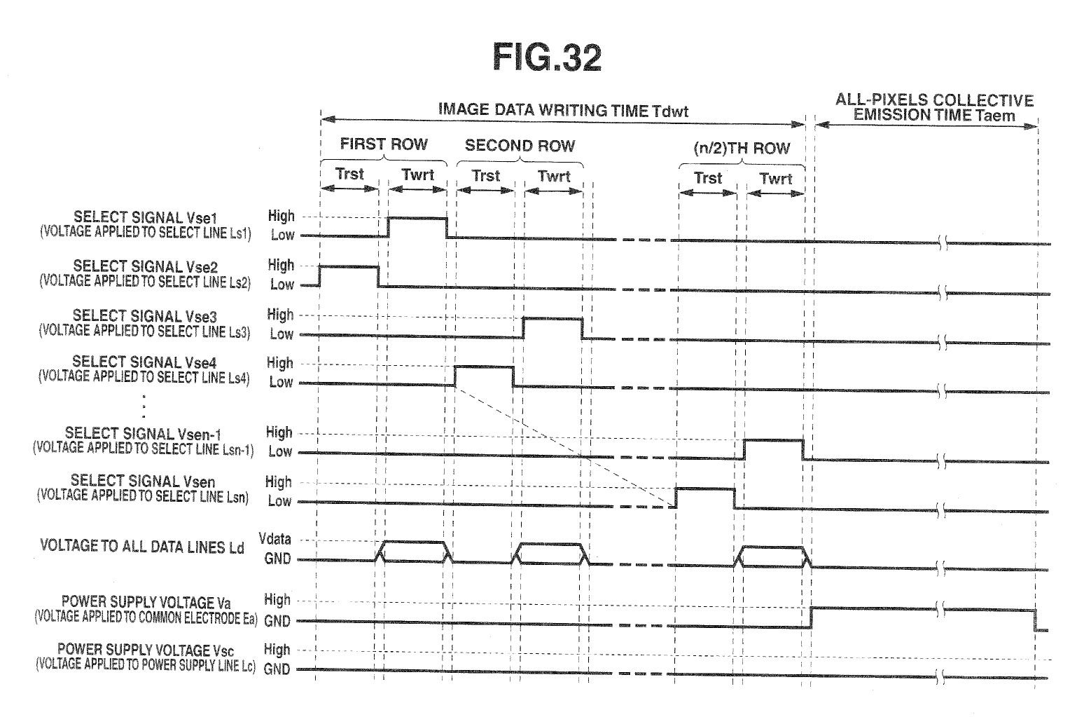

FIG. 32 is a timing chart in the case where the display operation according to the present embodiment is applied to the display panel in which the pixels are two-dimensionally arranged.

Here, the display operation equivalent to that in the above-described first embodiment is simply described.

In order to perform the display operation in the display panel 110 shown in FIG. 20 in which the pixels PIX are two-dimensionally arranged, a series of operations comprising the reset operation and the Vdata writing operation is sequentially performed for the pixels PIX in the first row to n/2nd row of the display panel 110 in an image data writing time Tdwt, as shown in FIG. 32, as in the first embodiment described above.

First, in the reset time Trst, the select driver 120 applies the low-level select signals Vse1, Vse3 to Vsen to the select lines Ls1, Ls3 to Lsn, and also applies the high-level select signal Vse2 to the select line Ls2, as shown in FIG. 32.

Synchronously with this timing, the power supply driver 130 sets the power supply line Lc and the common electrode Ea at the ground potential GND.

In this condition, the data driver 140 simultaneously sets the data lines Ld in the respective rows at the ground potential GND.

As a result, in each pixel PIX in the first row, the potential of the contact N22 (the drain terminal of the transistor Tr23 or the cathode of the organic EL element OEL) of the pixel drive circuit DC is reset to the ground potential GND.

Then, in the Vdata writing time Twrt, the select driver 120 applies the high-level select signal Vse1 to the select lines Ls1 and also applies the low-level select signals. Vse2 to Vsen to the select lines Ls2 to Lsn, as shown in FIG. 32.

In this condition, the data driver 140 applies, to the data line Ld in each row, the gradation voltage Vdata which corresponds to the image data and which has been corrected in accordance with the luminance compensation data acquired by the luminance compensation data acquiring operation described above.

As a result, in the pixel PIX in the first row, the capacitor Cs of the pixel drive circuit. DC is filled with a charge corresponding to the gradation voltage Vdata, and the image data is written accordingly.

Then, as shown in FIG. 32, the series of operations for the pixel PIX in the first row described above is sequentially repeated for the pixels PIX in the second row to n/2nd row. Consequently, the gradation voltage Vdata which corresponds to the image data and which has been corrected in accordance with the correction amount based on the luminance compensation data acquired by the luminance compensation data acquiring operation described above written into all the pixels PIX arranged in the display panel 110.

Furthermore, in an all-pixels collective emission time Taem, the select driver 120 applies the low-level select signals Vse1 to Vsen to the select lines Ls1 to Lsn, as shown in FIG. 32.

In this condition, the power supply driver 130 applies the high-level power supply voltage Va to the common electrode Ea and also applies the low-level power supply voltage Vsc to the power supply line Lc.

Thus, in the pixels PIX in all the rows of the display panel 110, the light emission drive current Iel having a value corresponding to the gradation voltage Vdata runs through the transistor Tr23 which is a drive transistor of the pixel drive circuit DC. The organic EL element OEL in each pixel PIX emits light with the original luminance gradation corresponding to the image data. Consequently, desired image information is displayed on the display panel 110.

As described above, according to the display apparatus (light-emitting apparatus) and its drive control method of the present embodiment, the configuration of the data driver 140 is simplified, and the current Imeas adapted to the change in the light emission characteristic (I-V characteristic) of the organic EL element OEL of each pixel PIX is measured in a simple manner. In this way, the luminance compensation data can be acquired for each pixel PIX.

In this case, the power supply driver 130 (power supply circuits 131, 132) does not have to apply any power supply voltage having a negative voltage value to each pixel PIX. Thus, a low-breakdown-voltage circuit configuration can be applied as the power supply driver 130, and manufacturing costs can be reduced.

Moreover, the gradation voltage Vdata which has been corrected in accordance with the change in the light emission characteristic of the organic EL element OEL provided in each pixel PIX can be written during writing of the image data into each pixel PIX.

As a result, the light emission drive current Iel having the original value corresponding to the image data can be passed through the organic EL element OEL independently of the state of characteristic change in the organic EL element OEL. Thus, the organic EL element OEL can emit light with a proper luminance gradation corresponding to the image data, and high and uniform image quality can be obtained.

(Pixel Defect Detecting Method for Light-Emitting Apparatus)

Now, another example (pixel defect detecting method) of the drive control method of the display apparatus according to the present embodiment is described with reference to the drawings.

As in the first embodiment described above, the display apparatus according to the present embodiment can also be applied to the case where a defect of the pixels PIX arranged in the light-emitting panel (display panel) is detected. Details are described below.

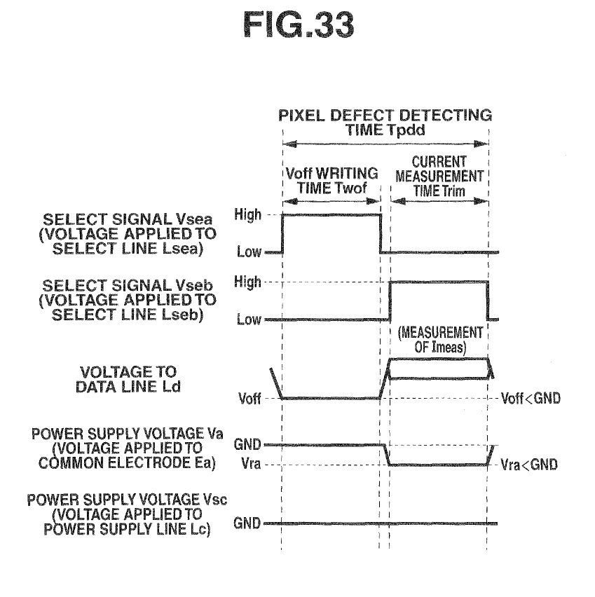

FIG. 33 is a timing chart showing a pixel defect detecting operation in the display apparatus according to the present embodiment.

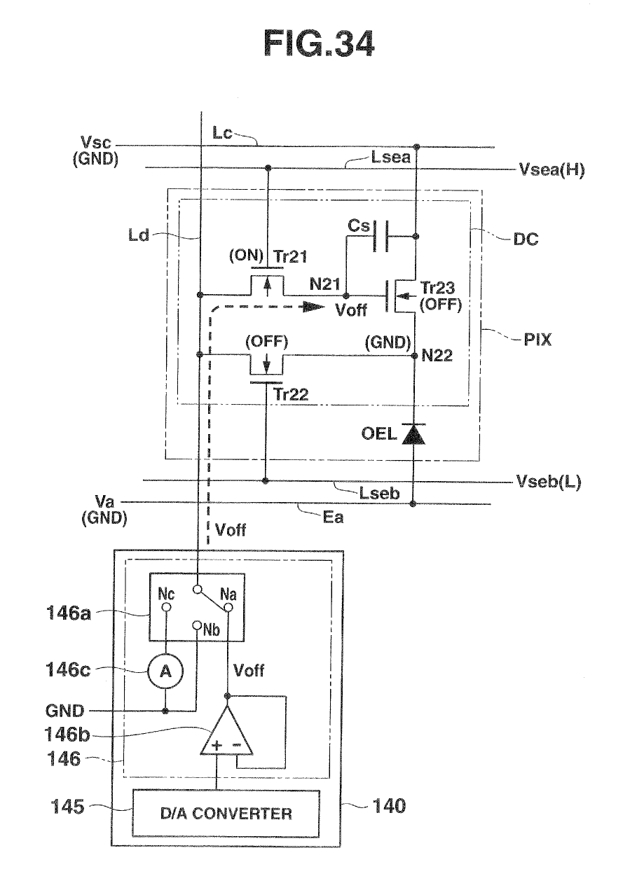

FIG. 34 is an operation concept diagram showing an off-voltage applying operation in the pixel defect detecting operation according to the present embodiment.

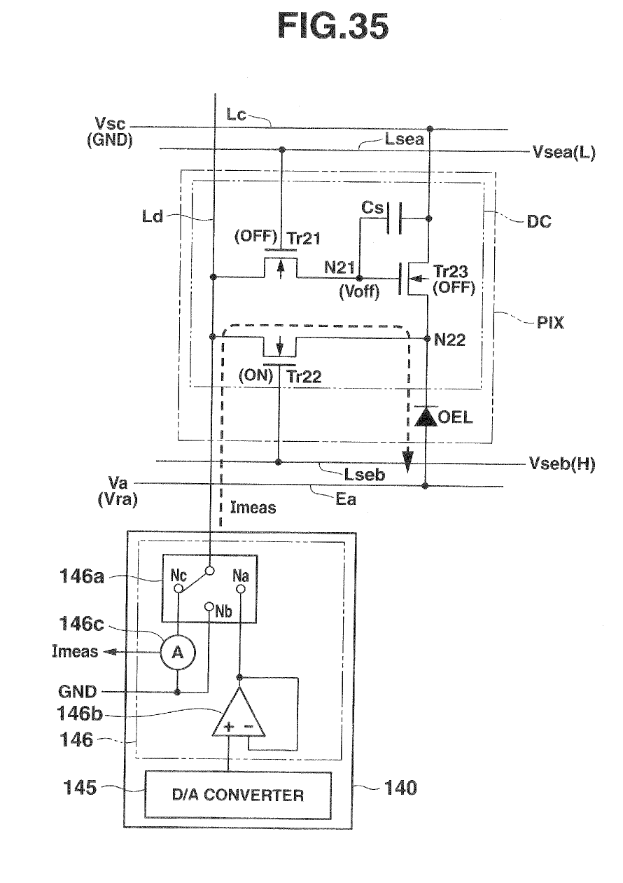

FIG. 35 is an operation concept diagram showing a current measuring operation in the pixel defect detecting operation according to the present embodiment.

Here, in FIG. 34 and FIG. 35, the D/A converter 145 and the output circuit 146 are only shown out of the data driver 140 shown in FIG. 21 for convenience of illustration.

A control operation equivalent to the luminance compensation data acquiring operation is described in a simplified manner.

The pixel defect detecting operation according to the present embodiment is executed to have a predetermined pixel defect detecting time Tpdd as shown in FIG. 33. The pixel defect detecting time Tpdd includes at least the Voff writing time Twof and the current measurement time Trim.

In the Voff writing time Twof, the off-voltage Voff is written into the pixel PIX, as in the luminance compensation data acquiring operation described above.

In the current measurement time Trim, the current Imeas running through the pixel PIX (organic EL element OEL) is measured while a reverse bias voltage is being applied to the organic EL element OEL.

First, in the Voff writing time Twof, the power supply driver 130 applies the power supply voltages Vsc and Va at the ground potential GND to the power supply line Lc and the common electrode Ea as shown in FIG. 33 and FIG. 34, as in the Voff writing operation of the luminance compensation data acquiring operation described above.

Furthermore, the select driver 120 applies the select signal Vsea at a high level (select level) to the select line Lsea and also applies the select signal Vseb at a low level (unselect level) to the select line Lseb.

Synchronously with this timing, as shown in FIG. 33 and FIG. 34, the data driver 140 switches/connects the changeover switch 146a to the contact Na, thereby applying the off-voltage Voff having a negative voltage at a potential lower than the ground potential GND to the data line Ld.

Thus, as shown in FIG. 34, the off-voltage Voff is applied to the gate terminal (contact N21) of the transistor Tr23 provided in the pixel drive circuit DC of the pixel PIX. This ensures that the current path between the drain and source of the transistor Tr23 is closed.

Then, in the current measurement time Trim, the select driver 120 applies the select signal Vsea at a low level (unselect level) to the select line Lsea and also applies the select signal Vseb at a high level (select level) to she select line Lseb, as sheen in FIG. 33 and FIG. 35.

Furthermore, the power supply driver 130 applies the power supply voltage Vsc having the ground potential GND to the power supply line Lc and also applies the power supply voltage Va which is a negative voltage Vra having a potential lower than the ground potential GND to the common electrode Ea.

Synchronously with this timing, as shown in FIG. 33 and FIG. 35, the data driver 140 switches/connects the changeover switch 146a to the contact Nc, thereby connecting a first end of the ammeter 146c to the data line Ld.

Here, the power supply voltage Va (=Vra) applied to the common electrode Ea is set a voltage value having a potential lower than the potential (Vn22≈ground potential GND) applied to the cathode (contact N22) of the organic EL element OEL (Vra>GND). Specifically, the power supply voltage Va (=Vra) is set at such a negative voltage value that the value of the current Imeas running to the common electrode Ea from the data line Ld through the transistor Tr22 and the organic EL element OEL can be measured by the ammeter 146c.

Thus, as shown in FIG. 35, the transistor Tr21 turns off, and the off-voltage Voff applied to the gate terminal (contact N21) of the transistor Tr23 is maintained.

Furthermore, the transistor Tr22 turns on. Accordingly, the drain terminal (contact N22) of the transistor Tr23 is connected to the first end side of the ammeter 146c through the transistor Tr22 and the data line Ld. The source terminal of the transistor Tr23 is set at the ground potential GND by she power supply voltage Vsc.

Thus, a reverse bias condition is set in which a higher voltage is applied to the cathode side (contact N22) of the organic EL element OEL than in the anode side (common electrode La). Therefore, the minute current Imeas corresponding to the reverse bias voltage and the element characteristic of the organic EL element OEL runs through the organic EL element OEL in the reverse direction.

At the same time, the value of the current Imeas running to the pixel PIX from the data line Ld is measured by the ammeter 146c connected to the data line Ld.

The current Imeas measured by the series of pixel defect detecting operations described above is applied to a pixel defect judging process directly or after converted into digital data by, for example, the A/D converter 147 shown in FIG. 21.

In the pixel defect judging process, as in the first embodiment described above, a stipulated value Ist is acquired in advance by using, for example, a simulation based on the element structure of the organic EL element OEL or design data or by executing the above-described series of pixel defect detecting operations for the pixel PIX provided with the organic EL element OEL having a normal characteristic. Then, the value of the current Imeas measured for a particular pixel PIX is compared with the current value of the stipulated value Ist. In accordance with the result of the comparison, whether the pixel PIX having this organic EL element OEL is a defective pixel is judged (pixel defect judging step).

Thus, according to the pixel defect detecting method for the display apparatus of the present embodiment, as in the first embodiment described above, whether the relevant pixel PIX (organic EL element OEL) is defective can be judged in accordance with the current Imeas measured by a simple technique for the organic EL element OEL of each of the pixels PIX arranged in the display panel 110.

In the first and second embodiments described above, as a means of detecting a variation in the characteristic (current-voltage characteristic) of a light-emitting element, the value of the current Imeas running through the light-emitting element is measured while the particular reference voltage Vmeas is being applied to the pixel PIX through the data line thereby acquiring this value as the luminance compensation data. The present invention is not limited to this. The particular reference current may be passed through (passed into or drawn from) each pixel PIX through the data line Ld to measure the value of a voltage generated across the ends of the light-emitting element, thereby acquiring this value as the luminance compensation data.

### Third Embodiment

Now, an electronic device to which the display panel (light-emitting panel) according to the first and second embodiments is applied is described as a third embodiment with reference to the drawings.

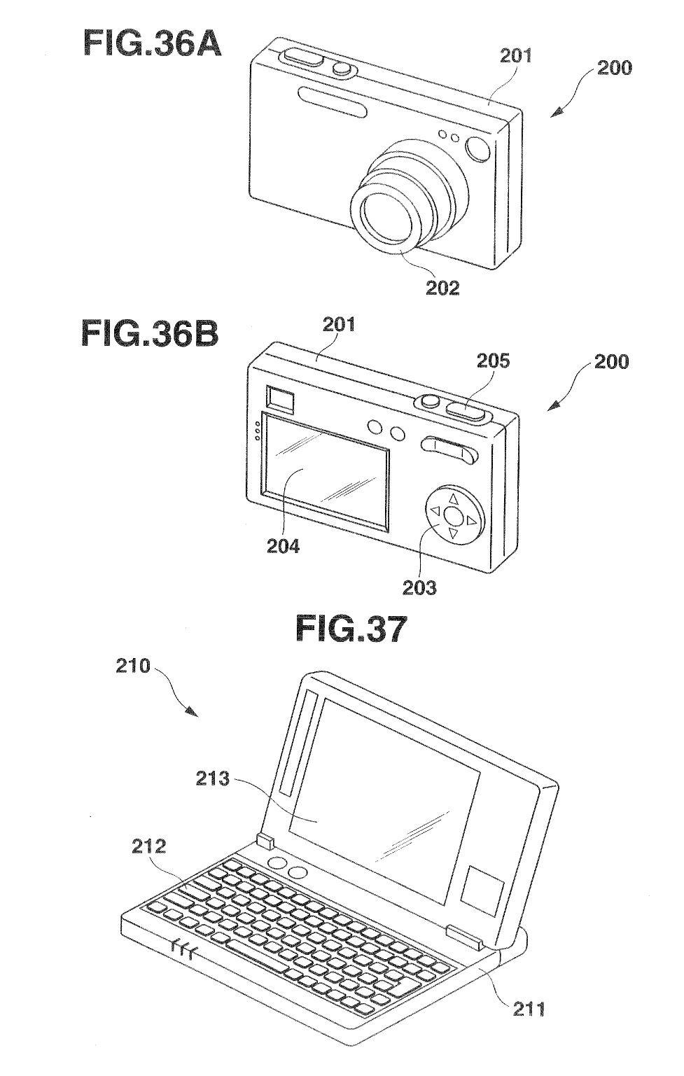

FIGS. 36A and 36B are perspective views showing the configuration of a digital camera according to the present embodiment.

FIG. 37 is a perspective view showing the configuration of a personal computer according to the present embodiment.

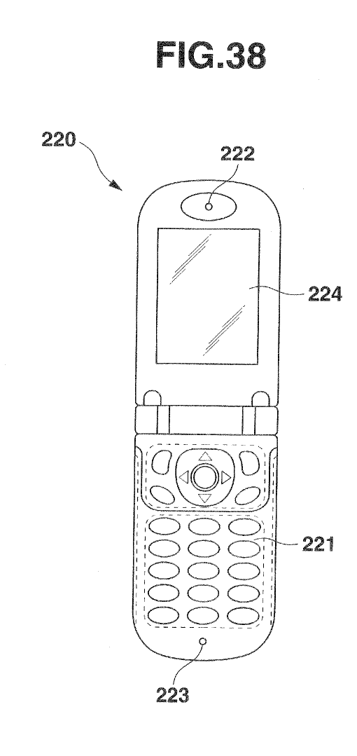

FIG. 38 is a view showing the configuration of a mobile telephone according to the present embodiment.

The above-described display panel 110 in which the light-emitting element comprising the organic EL element OEL is provided in each pixel PIX is applicable to various electronic, devices such as a digital camera, mobile personal computer or mobile telephone.

In FIGS. 36A and 36B, a digital camera 200 generally includes a main unit 201, a lens unit 202, an operation unit 203, a display unit 204 including the display panel 110 shown in the embodiments described above, and a shutter button 205. Thereby, in the display unit 204, the light-emitting elements of the pixels in the display panel 110 emit light with a proper luminance gradation corresponding to image data. This enables satisfactory and uniform image display.

In FIG. 37, a personal computer 210 generally includes a main unit 211, a keyboard 212, and a display unit 213 including the display panel 110 shown in the embodiments described above. In this case as well, in the display unit 213, the light-emitting elements of the pixels in the display panel 110 emit light with a proper luminance gradation corresponding to image data. This enables satisfactory and uniform image display.

In FIG. 38, mobile telephone 220 generally includes an operation unit 221, an earpiece 222, a mouthpiece 223, and a display unit 224 including the display panel 110 shown in the embodiments described above. In this case as well, in the display unit 224, the light-emitting elements of the pixels in the display panel 110 emit light with a proper luminance gradation corresponding to image data. This enables satisfactory and uniform image display.

In the embodiments described above, the display apparatus and ids drive control method according to the present invention are applied to the display panel 110 in which the pixels PIX having the light-emitting elements comprising the organic EL elements OEL are two-dimensionally arranged. However, the present invention is not limited to this.

That is, the present invention may be applied to, for example, an exposure apparatus, which includes a light-emitting element array in which pixels having light-emitting elements are arranged in one direction. Light emitted from this light-emitting element array in accordance with image data is applied to a photoconductor drum to carry out exposure. In this case as well, the light-emitting elements of the pixels in the light-emitting element array can emit light, with a proper luminance corresponding to the image data. This enables satisfactory exposure.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A light-emitting apparatus comprising:
a light-emitting panel provided with at least one pixel and a data line connected to the pixel; and
a drive circuit connected to the light-emitting panel,
wherein the pixel includes a light-emitting element, a drive transistor, and a first switching element,
the drive transistor includes a current path having a first end side connected to the light-emitting element and a second end side to be supplied with a power supply voltage,
the first switching element is provided between the first end side of the current path of the drive transistor and the data line, and
the drive circuit includes a measurement circuit to connect the data line and the light-emitting element through the first switching element after no current is set to run through the current path of the drive transistor, acquiring an electric characteristic of the light-emitting element through the data line and the first switching element, the electric characteristic comprising a relation between a voltage applied to the light-emitting element and a current running through the light-emitting element.

2. The light-emitting apparatus according to claim 1, further comprising:
power supply circuit to supply the power supply voltage,
wherein the drive circuit cuts the connection between the power supply circuit and the second end side of the current path of the drive transistor to set no current to run through the current path of the drive transistor.

3. The light-emitting apparatus according to claim 1, wherein the drive circuit sets the power supply voltage to a voltage value at which no current runs through the current path of the drive transistor, and the drive circuit also applies a predetermined off-voltage to turn off the drive transistor to a control terminal of the drive transistor, so that no current runs through the current path of the drive transistor.

4. The light-emitting apparatus according to claim 3, wherein
the pixel includes a second switching element provided between the control terminal of the drive transistor and the data line, and a storage capacitance provided between the control terminal of the drive transistor and the first end side of the current path of the drive transistor, and
the drive circuit brings both ends of the storage capacitance close to the same potential through the data line, the first switching element, and the second switching element to discharge a charge accumulated in the storage capacitance before the application of the off-voltage.

5. The light-emitting apparatus according to claim 1, wherein
the drive circuit includes
a voltage applying circuit, to apply a measurement voltage to the data line,
a current measurement circuit to acquire a value of a current running through the light-emitting element in response to the application of the measurement voltage through the data line and the first switching element.

6. The light-emitting apparatus according to claim 5, wherein the voltage applying circuit applies, as the measurement voltage, a voltage to be a forward bias to the light-emitting element.

7. The light-emitting apparatus according to claim 5, wherein the voltage applying circuit applies, as the measurement voltage, a voltage to be a reverse bias to the light-emitting element.

8. The light-emitting apparatus according to claim 1, wherein the drive circuit includes
a storage circuit to store, as luminance compensation data, at least one of a voltage value and a current value in the electric characteristic of the light-emitting element acquired by the measurement circuit, and
a correction operating circuit to extract a correction amount based on a comparison of the luminance compensation data stored in the storage circuit with a predetermined reference value, correcting externally supplied image data in accordance with the correction amount.

9. The light-emitting apparatus according to claim 1, wherein the light-emitting element comprises an organic electroluminescent element.

10. An electronic device comprising:
an electronic device main unit; and
a light-emitting apparatus to be supplied with image data from the electronic device main unit and driven in accordance with the image data,
the light-emitting apparatus including
a light-emitting panel provided with at least one pixel and a data line connected to the pixel; and
a drive circuit connected to the light-emitting panel,
wherein the pixel includes a light-emitting element, a drive transistor, and a first switching element,
the drive transistor includes a current path having a first end side connected to the light-emitting element and a second end side to be supplied with a power supply voltage,
the first switching element is provided between the first end side of the current path of the drive transistor and the data line, and
the drive circuit includes a measurement circuit to connect the data line and the light-emitting element through the first switching element after no current is set to run through the current path of the drive transistor, acquiring an electric characteristic of the light-emitting element through the data line and the first switching element, the electric characteristic comprising a relation between a voltage applied to the light-emitting element and a current running through the light-emitting element.

11. A drive control, method of a light-emitting apparatus, the method comprising:
a preparation step of preparing the light-emitting apparatus comprising a data line and at least one pixel, the pixel including a light-emitting element, a drive transistor provided with a current path having a first end side connected to the light-emitting element and a second end side to be supplied with a power supply voltage, and a first switching element provided between the first end side of the current path of the drive transistor and the data line;
a cutting step of setting no current to run through the current path of the drive transistor;
a connecting step of connecting the data line and the light-emitting element through the first switching element after the cutting step is executed; and
a characteristic measuring step of acquiring an electric characteristic of the light-emitting element through the data line and the first switching element with the data line and the light-emitting element being connected through the first switching element by the connecting step, the electric characteristic comprising a relation between a voltage applied to the light-emitting element and a current running through the light-emitting element.

12. The drive control method according to claim 11, wherein the cutting step includes a connection cutting step of cutting the connection between the power supply circuit to supply the power supply voltage and the second end side of the current path of the drive transistor, setting no current to run through the current path of the drive transistor.

13. The drive control method according to claim 11, wherein the cutting step includes
a power supply voltage setting step of setting the power supply voltage to a voltage value at which no current runs through the current path of the drive transistor, and
an off-voltage applying step of applying a predetermined off-voltage to turn off the drive transistor to a control terminal of the drive transistor, so that no current runs through the current path of the drive transistor.

14. The drive control method according to claim wherein
the pixel includes a second switching element provided between the control terminal of the drive transistor and the data line, and a storage capacitance provided between the control terminal of the drive transistor and the first end side of the current path of the drive transistor,
the method further comprising an initialization step, executed before the off-voltage applying step, to bring both ends of the storage capacitance close to the same potential through the data line, the first switching element, and the second switching element to discharge a charge accumulated in the storage capacitance.

15. The drive control method according to claim 11, further comprising:
a compensation data storing step of storing, in a storage circuit as luminance compensation data, at least one of a voltage value and a current value in the electric characteristic of the light-emitting element acquired by the characteristic measuring step;
a correction amount extracting step of extracting correction amount based on a comparison of the luminance compensation data stored in the storage circuit with a predetermined reference value; and
a correcting step of correcting externally supplied image data in accordance with the correction amount.

16. The drive control method according to claim 11, wherein the characteristic measuring step includes
a voltage applying step of applying a measurement voltage to the data line, and
a current measuring step of measuring a value of current running through the light-emitting element in response to the application of the measurement voltage through the data line and the first switching element.

17. The drive control method according to claim 16, wherein the voltage applying step includes applying, as the measurement voltage, a voltage to be a forward bias to the light-emitting element.

18. The drive control method according to claim 16, wherein the voltage applying step includes applying, as the measurement voltage, a voltage to be a reverse bias to the light-emitting element.

19. The drive control method according to claim 18, wherein the characteristic measuring step further includes a pixel defect judging step of judging whether the pixel provided with the light-emitting element is a defective pixel in accordance with the current value measured by the current measuring step when the voltage to be the reverse bias is applied to the light-emitting element as the measurement voltage by the voltage applying step.
